(19) United States
(12) Patent Application Publication
(10) Pub. No.: US 2025/0166235 A1
(43) Pub. Date: May 22, 2025

(54) NEURAL NETWORK COMPLEXITY METRIC FOR IMAGE PROCESSING

(71) Applicant: Telefonaktiebolaget LM Ericsson (publ), Stockholm (SE)

(72) Inventors: Martin PETTERSSON, Vallentuna (SE); Rickard SJÖBERG, Stockholm (SE); Mitra DAMGHANIAN, Upplands-Bro (SE); Jacob STRÖM, Stockholm (SE)

(73) Assignee: Telefonaktiebolaget LM Ericsson (publ), Stockholm (SE)

(21) Appl. No.: 18/840,553

(22) PCT Filed: Feb. 16, 2023
(86) PCT No.: PCT/SE2023/050137

§ 371 Date: Aug. 22, 2024

Related U.S. Application Data
(60) Provisional application No. 63/314,179, filed on Feb. 25, 2022.

(51) Int. Cl. G06T 9/00; H04L 12/18; H04L 65/1101

(52) U.S. Cl. CPC G06T 9/002; H04L 12/1827; H04L 65/1101

(57) ABSTRACT

There is provided a method performed by a first entity. The method comprises obtaining decoding information and conveying the obtained decoding information towards a second entity, wherein the decoding information includes at least one neural network, NN, complexity value, and the at least one NN complexity value indicates NN decoding capability for using one or more NN models in a decoding process of a video bitstream.

### TECHNICAL FIELD

This disclosure relates to methods and apparatus for conveying neural network complexity metric for image processing.

### BACKGROUND

### HEVC and VVC

Versatile Video Coding (VVC) and its predecessor High Efficiency Video Coding (HEVC) are block-based video codecs standardized and developed jointly by ITU-T and MPEG. The codecs utilize both temporal and spatial prediction. VVC and HEVC are similar in many aspects. Spatial prediction is achieved using intra (I) prediction from within the current picture. Temporal prediction is achieved using uni-directional (P) or bi-directional inter (B) prediction on block level from previously decoded reference pictures.

In the encoder, the difference between the original pixel data and the predicted pixel data, referred to as the residual, is transformed into the frequency domain, quantized and then entropy coded before transmitted together with necessary prediction parameters such as prediction mode and motion vectors, also entropy coded. The decoder performs entropy decoding, inverse quantization and inverse transformation to obtain the residual, and then adds the residual to an intra or inter prediction to reconstruct a picture.

The VVC version 1 specification was published as Rec. ITU-T H.266| ISO/IEC 23090-3, “Versatile Video Coding”, in 2020. MPEG and ITU-T are working together within the Joint Video Exploratory Team (JVET) on updated versions of HEVC and VVC as well as the successor to VVC, i.e. the next generation video codec.

### Components

A video sequence consists of a series of images where each image consists of one or more components. Each component can be described as a two-dimensional rectangular array of sample values. It is common that an image in a video sequence consists of three components; one luma component Y where the sample values are luma values and two chroma components Cb and Cr, where the sample values are chroma values. It is also common that the dimensions of the chroma components are smaller than the luma components by a factor of two in each dimension. For example, the size of the luma component of an HD image would be 1920×1080 and the chroma components would each have the dimension of 960×540. Components are sometimes referred to as color components.

### Blocks and Units

A block is one two-dimensional array of samples. In video coding, each component is split into blocks and the coded video bitstream consists of a series of coded blocks. It is common in video coding that the image is split into units that cover a specific area of the image. Each unit consists of all blocks from all components that make up that specific area and each block belongs fully to one unit. The macroblock in H.264 and the Coding unit (CU) in HEVC are examples of units.

A block can alternatively be defined as a two-dimensional array that a transform used in coding is applied to. These blocks are known under the name “transform blocks”. Alternatively, a block can be defined as a two-dimensional array that a single prediction mode is applied to. These blocks can be called “prediction blocks”. In this application, the word block is not tied to one of these definitions but that the descriptions herein can apply to either definition.

### Residuals, Transforms and Quantization

A residual block consists of samples that represents sample value differences between sample values of the original source blocks and the prediction blocks. The residual block is processed using a spatial transform. In the encoder, the transform coefficients are quantized according to a quantization parameter (QP) which controls the precision of the quantized coefficients. The quantized coefficients can be referred to as residual coefficients. A high QP value would result in low precision of the coefficients and thus low fidelity of the residual block. A decoder receives the residual coefficients, applies inverse quantization and inverse transform to derive the residual block.

### Coding Tools

A video codec includes a set of coding tools, where a coding tool may be described as a distinct feature of the codec that typically improves compression or decreases the complexity of the decoding. Coding tools can typically be turned on or off on a sequence level, picture level and block level to balance the compression efficiency and complexity.

Examples of coding tools that are new to VVC compared to HEVC include Luma Mapping with Chroma Scaling (LMCS), Adaptive Loop Filter (ALF), Dependent Quantization (DQ), Low Frequency Non-Separable Transform (LFNST), Adaptive Motion Vector Resolution (AMVR), Decoder-side Motion Vector Resolution (DMVR), Bi-Directional Optical Flow (BDOF), Flexible block partitioning with multi-type Tree (MTT), Cross-Component Linear Model (CCLM), Intra Block Copy (IBC), Reference Picture Resampling (RPR), Matrix Based Intra Prediction (MIP), Combined Intra/Inter Prediction (CIIP) and affine motion compensation.

The next generation video codec is also expected to add a number of new coding tools compared to VVC, possibly including one or more NN-based coding tools.

### NAL Units

Both VVC and HEVC define a Network Abstraction Layer (NAL). All the data, i.e. both Video Coding Layer (VCL) or non-VCL data in HEVC and VVC is encapsulated in NAL units. A VCL NAL unit contains data that represents picture sample values. A non-VCL NAL unit contains additional associated data such as parameter sets and supplemental enhancement information (SEI) messages. The NAL unit in VVC and HEVC begins with a header called the NAL unit header. The syntax for the NAL unit header for HEVC starts with a forbidden_zero_bit that shall always be equal to 0 to prevent start code emulations.

Without it, some MPEG systems might confuse the HEVC video bitstream with other data, but the 0 bit in the NAL unit header makes all possible HEVC bitstreams uniquely identifiable as HEVC bitstreams. The NAL unit header in VVC is very similar to the one in HEVC, but uses 1 bit less for the nal_unit_type and instead reserves this bit for future use. The nal_unit_type, nuh_layer_id and nuh_temporal_id_plus1 code words specify the NAL unit type of the NAL unit that identifies what type of data is carried in the NAL unit, the scalability layer ID and the temporal layer ID for which the NAL unit belongs to. The NAL unit type indicates and specifies how the NAL unit should be parsed and decoded. The rest of the bytes of the NAL unit is payload of the type indicated by the NAL unit type. A bitstream consists of a series of concatenated NAL units.

### Picture Unit, Access Unit and the Access Unit Delimiter

A picture unit (PU) in VVC is defined as a set of NAL units for which the VCL NAL units all belong to the same layer, that are associated with each other according to a specified classification rule, that are consecutive in decoding order, and that contain exactly one coded picture. In previous versions of VVC, the PU was called layer access unit. In HEVC, the PU is referred to as an access unit (AU).

In VVC, an access unit is a set of PUs that belong to different scalability layers and contain coded pictures associated with the same time for output from the decoded picture buffer (DPB), i.e. having the same POC value.

An access unit, in VVC, may start with an access unit delimiter (AUD) NAL unit which indicates the start of the access unit and the type of the slices allowed in the coded picture, i.e. I, I-P or I-P-B and whether the access unit is an IRAP or GDR access unit.

### Temporal Sublayers

In HEVC and in VVC, all pictures are associated with a TemporalId value which specified what temporal sublayer the picture belongs to. TemporalId values are decoded from the nuh_temporal_id_plus1 syntax element in the NAL unit header. The encoder is required to set TemporalId values such that pictures belonging to a lower temporal sublayer is perfectly decodable when higher temporal sublayers are discarded.

Assume for instance that an encoder has output a bitstream using temporal sublayers 0, 1 and 2. Then removing all sublayer 2 NAL units or removing all sublayer 1 and 2 NAL units will result in bitstreams that can be decoded without problems. This is ensured by restrictions in the HEVC specification that the encoder must comply with. For instance, it is not allowed for a picture of a temporal sublayer to reference a picture of a higher temporal sublayer.

### Layers and Scalability

The value of the nuh_layer_id syntax element in the NAL unit header specifies the layer ID to which the NAL unit belongs to.

A layer access unit in VVC is defined as a set of NAL units for which the VCL NAL units all have a particular value of nuh_layer_id, that are associated with each other according to a specified classification rule, that are consecutive in decoding order, and that contain exactly one coded picture.

A coded layer video sequence (CLVS) in the VVC is defined as a sequence of layer access units that consists, in decoding order, of a CLVS layer access unit, followed by zero or more layer access units that are not CLVS layer access units, including all subsequent layer access units up to but not including any subsequent layer access unit that is a CLVS layer access unit.

The relation between the layer access units and coded layer video sequences is illustrated in FIG. 10.

In VVC, layers may be coded independently or dependently from each other. When the layers are coded independently, a layer with e.g. nuh_layer_id 0 may not predict video data from another layer with e.g. nuh_layer_id 1. In VVC, dependent coding between layers may be used, which enables support for scalable coding with SNR, spatial and view scalability.

### Picture Header

In VVC, a coded picture contains a picture header structure. The picture header structure contains syntax elements that are common for all slices of the associated picture. The picture header structure may be signaled in its own non-VCL NAL unit with NAL unit type PH NUT or included in the slice header given that there is only one slice in the coded picture.

This is indicated the by slice header syntax element picture_header_in_slice_header_flag, where a value equal to 1 specifies that the picture header structure is included in the slice header and a value equal to 0 specifies that the picture header structure is carried in its own PH NAL unit. For a CVS where not all pictures are single-slice pictures, each coded picture must be preceded by a picture header that is signaled in its own NAL unit. HEVC does not support picture headers.

### Intra Random Access Point (IRAP) Pictures and the Coded Video Sequence (CVS)

For single scalability layer coding in HEVC, an access unit (AU) is the coded representation of a single picture. An AU may consist of several video coding layer (VCL) NAL units as well as non-VCL NAL units.

An intra random access point (IRAP) picture in HEVC is a picture that does not refer to any pictures other than itself for prediction in its decoding process. The first picture in the bitstream in decoding order in HEVC must be an IRAP picture but an IRAP picture may additionally also appear later in the bitstream. HEVC specifies three types of IRAP pictures, the broken link access (BLA) picture, the instantaneous decoder refresh (IDR) picture and the clean random access (CRA) picture.

A coded video sequence (CVS) in HEVC is a sequence of access units starting at an IRAP access unit followed by zero or more AUs up to, but not including the next IRAP access unit in decoding order.

IDR pictures always start a new CVS. An IDR picture may have associated random access decodable leading (RADL) pictures. An IDR picture does not have associated random access skipped leading (RASL) pictures.

BLA picture in HEVC also starts a new CVS and has the same effect on the decoding process as an IDR picture. However, a BLA picture in HEVC may contain syntax elements that specify a non-empty set of reference pictures. A BLA picture may have associated RASL pictures, which are not output by the decoder and may not be decodable, as they may contain references to pictures that may not be present in the bitstream. A BLA picture may also have associated RADL pictures, which are decoded. BLA pictures are not included in VVC.

A CRA picture may have associated RADL or RASL pictures. As with a BLA picture, a CRA picture may contain syntax elements that specify a non-empty set of reference pictures. For CRA pictures, a flag can be set to specify that the associated RASL pictures are not output by the decoder, because they may not be decodable, as they may contain references to pictures that are not present in the bitstream. A CRA may or may not start a CVS.

In VVC, a CVS is a sequence of access units starting at a CVS start (CVSS) access unit followed by zero or more AUs up to, but not including the next CVSS access unit in decoding order. A CVSS access unit may contain an IRAP picure, i.e, an IDR or a CRA picture, or a gradual decoding refresh (GDR) picture. A CVS may contain one or more CLVSs.

GDR pictures are essentially used for random access in bitstreams encoded for low-delay coding where a full IRAP picture would cause too much delay. A GDR picture may use gradual intra refresh that updates the video picture by picture where each picture is only partially intra coded. A recovery POC count is signaled with the GDR picture that specifies when the video is fully refreshed and ready for output, given that the bitstream was tuned in at the GDR picture. A GDR picture in VVC may start a CVS or CLVS. GDR pictures are included as a normative feature in VVC but are not a normative part of the HEVC standard, where it instead may be indicated with an SEI message.

### Parameter Sets

HEVC and VVC specifies three types of parameter sets, the picture parameter set (PPS), the sequence parameter set (SPS) and the video parameter set (VPS). The PPS contains data that is common for a whole picture, the SPS contains data that is common for a coded video sequence (CVS) and the VPS contains data that is common for multiple CVSs, e.g. data for multiple scalability layers in the bitstream.

VVC version 1 also specifies one additional parameter set, the adaptation parameter set (APS). The APS carries parameters needed for the adaptive loop filter (ALF) tool, the luma mapping and chroma scaling (LMCS) tool and the scaling list tool.

Both HEVC and VVC allow certain information (e.g. parameter sets) to be provided by external means. “By external means” should be interpreted as the information is not provided in the coded video bitstream but by some other means not specified in the video codec specification, e.g. via metadata possibly provided in a different data channel, as a constant in the decoder, or provided through an API to the decoder.

### Decoding Capability Information (DCI)

In VVC there is a DCI NAL unit. The DCI specifies information that don't change during the decoding session and may be good for the decoder to know about early and upfront, such as profile and level information. The information in the DCI is not necessary for operation of the decoding process. In drafts of the VVC specification the DCI was called decoding parameter set (DPS).

The decoding capability information may also contain a set of general constraints for the bitstream, that gives the decoder information of what to expect from the bitstream, in terms of coding tools, types of NAL units, etc. In VVC version 1, the general constraint information (GCI) can be signaled in the DCI, VPS or SPS.

### The OLS and OPI

The VPS in VVC contains scalability layer information that is needed for handling scalable bitstreams. For VVC single-layer bitstreams, the VPS is optional so in those bitstreams the VPS may or may not be present. For HEVC, a VPS must be present for all bitstreams, even single-layer ones. The VPS defines output layer sets (OLS), where an OLS is a set of layers in the bitstream and indications of which of the layers in the OLS that should be output.

In VVC, only the output layers are specified and the full OLS is derived by using bitstream information for how layers reference other layers. This means that the full OLS is decodable even if all layers that are not included in the OLS are discarded. In other word, no layer in an OLS depend on any layer not in the OLS. This also means that some OLS layers may be required to be decoded but no pictures of those layers are output.

An operation point in VVC is defined as a temporal subset of an OLS, identified by an OLS index and a highest value of TemporalId. The operation point information (OPI) in VVC can be used to specify the OLS index of the target OLS for the decoder to decode. The OPI may additionally specify the highest temporal sublayer the decoder should decode. When a bitstream contains many layers and sublayers, the OPI can be useful to tell a decoder what parts of the bitstream to decode and/or what temporal sublayers that should be discarded when decoding.

The target OLS and highest temporal sublayer to decode can alternatively be specified by external means. If that happens and there is an OLS in the bitstream, the decoder should use the information provided by external means and ignore the OLS information. The OPI is signaled in its own non-VCL NAL unit in VVC.

### SEI Messages

Supplementary Enhancement Information (SEI) messages are codepoints in the coded bitstream that do not influence the decoding process of coded pictures from VCL NAL units. SEI messages usually address issues of representation/rendering of the decoded bitstream. The overall concept of SEI messages and many of the messages themselves have been inherited from the H.264 and HEVC specifications into the VVC specification. In VVC, an SEI RBSP contains one or more SEI messages.

SEI messages assist in processes related to decoding, display or other purposes. However, SEI messages are not required for constructing the luma or chroma samples by the decoding process. Some SEI messages are required for checking bitstream conformance and for output timing decoder conformance. Other SEI messages are not required for checking bitstream conformance. A decoder is not required to support all SEI messages. Usually, if a decoder encounters an unsupported SEI message, it is discarded.

ITU-T H.274|ISO/IEC 23002-7, also referred to as VSEI, specifies the syntax and semantics of SEI messages and is particularly intended for use with VVC, although it is written in a manner intended to be sufficiently generic that it may also be used with other types of coded video bitstreams. The first version of ITU-T H.274|ISO/IEC 23002-7 was finalized in July 2020. At the time of writing, version 2 is under development.

### Slices

The concept of slices in HEVC divides the picture into independently coded slices, where decoding of one slice in a picture is independent of other slices of the same picture. Different coding types could be used for slices of the same picture, i.e. a slice could either be an I-slice, P-slice or B-slice. One purpose of slices is to enable resynchronization in case of data loss. In HEVC, a slice is a set of CTUs.

In VVC, a slice is defined as an integer number of complete tiles or an integer number of consecutive complete CTU rows within a tile of a picture that are exclusively contained in a single NAL unit. In VVC, a picture may be partitioned into either raster scan slices or rectangular slices. A raster scan slice consists of a number of complete tiles in raster scan order. A rectangular slice consists of a group of tiles that together occupy a rectangular region in the picture or a consecutive number of CTU rows inside one tile. Each slice has a slice header comprising syntax elements. Decoded slice header values from these syntax elements are used when decoding the slice. Each slice is carried in one VCL NAL unit.

In an early draft of the VVC specification, slices were referred to as tile groups.

### Tiles

The VVC video coding standard includes a tool called tiles that divides a picture into rectangular spatially independent regions. Tiles in VVC are similar to the tiles used in HEVC. Using tiles, a picture in VVC can be partitioned into rows and columns of CTUs where a tile is an intersection of a row and a column.

### Subpictures

Subpictures are supported in VVC where a subpicture is defined as a rectangular region of one or more slices within a picture. This means a subpicture contains one or more slices that collectively cover a rectangular region of a picture. In the VVC specification subpicture location and size are signaled in the SPS. Boundaries of a subpicture region may be treated as picture boundaries (excluding in-loop filtering operations) conditioned to a per-subpicture flag subpic_treated_as_pic_flag[i] in the SPS. Also loop-filtering on subpicture boundaries is conditioned to a per-subpicture flag loop_filter_across_subpic_enabled_flag[i] in the SPS.

### Picture Order Count (POC)

Pictures in HEVC are identified by their picture order count (POC) values, also known as full POC values. Each slice contains a code word, pic_order_cnt_lsb, that shall be the same for all slices in a picture. pic_order_cnt_lsb is also known as the least significant bits (lsb) of the full POC since it is a fixed-length code word and only the least significant bits of the full POC is signaled. Both encoder and decoder keep track of POC and assign POC values to each picture that is encoded/decoded.

The pic_order_cnt_lsb can be signaled by 4-16 bits. There is a variable MaxPicOrderCntLsb used in HEVC which is set to the maximum pic_order_cnt_lsb value plus 1. This means that if 8 bits are used to signal pic_order_cnt_lsb, the maximum value is 255 and MaxPicOrderCntLsb is set to 2\hat{ }8=256. The picture order count value of a picture is called PicOrderCntVal in HEVC. Usually, PicOrderCntVal for the current picture is simply called PicOrderCntVal.

### Reference Picture Management

Reference picture management in HEVC is done using reference pictures sets (RPS). The reference picture set is a set of reference pictures that is signaled in the slice headers. When the decoder has decoded a picture, it is put together with its POC value in a decoded picture buffer (DPB). When decoding a subsequence picture, the decoder parses the RPS syntax from the slice header and constructs lists of reference picture POC values.

The reference picture management in the VVC specification differ slightly from the one in HEVC. In HEVC, the RPS is signaled and the reference picture lists to use for Inter prediction is derived from the RPS. In the VVC specification, the reference pictures lists (RPL) are signaled and the RPS is derived. However, in both specifications, signaling of what pictures to keep in the DPB, what pictures should be short-term and long-term is done. Using POC for picture identification and determination of missing reference pictures is done the same in both specifications.

### Profiles, Tiers and Levels

A profile in HEVC and VVC is defined as a specified subset of the syntax of the specification.

VVC version 1 comprises the Main 10 profile, the Main 10 Still Picture profile, the Main 10 4:4:4 profile, the Main 10 4:4:4 Still Picture profile, the Multilayer Main 10 profile and the Multilayer Main 10 4:4:4 profile where the 10 indicates support of a bitdepth of 10 bits per pixel and 4:4:4 indicates support of 4:4:4 chroma sampled pixels.

The Main 10, the Main 10 4:4:4 profile, the Multilayer Main 10 profile and the Multilayer Main 10 4:4:4 profile are video profiles while the Main 10 Still Picture and the Main 10 4:4:4 Still Picture profiles are still picture profiles. With the multilayer profiles scalability and multi-view coding is supported directly in version 1, which was not the case for the first version of HEVC. In version 2 of VVC a number of range extension profiles will be added for support of higher bit-depths. HEVC comprises similar profiles as VVC.

HEVC and VVC define a level as a defined set of constraints on the values that may be taken by the syntax elements and variables of the specification. The same set of levels is defined for all profiles, with most aspects of the definition of each level being in common across different profiles. Individual implementations may, within specified constraints, support a different level for each supported profile.

HEVC and VVC define a tier as a specified category of level constraints imposed on values of the syntax elements in the bitstream. The level constraints are nested within a tier. A bitstream in HEVC and VVC is said to conform to the specification at a specific profile, tier and level, where the profile, tier and level are signaled in the PTL structure in the bitstream. A decoder conforming to a certain tier and level is capable of decoding all bitstreams that conform to the same tier or the lower tier of that level or any level below it.

### MPEG Systems and Relevant Specifications

The MPEG systems group in MPEG develops systems standards for storing, transporting and presenting compressed media, including traditional video such as single layer HEVC and VVC encoded bitstreams, and immersive audio and video including 360 video and point clouds. This includes packetizing the compressed media, attaching appropriate metadata and make relevant information available to the systems and application layers, including network nodes and media players. Standards developed by the MPEG systems group relevant for this invention include the following specifications.

### ISO Base Media File Format

The ISO Base Media File Format (ISOBMFF) specified in ISO/IEC 14496-12 defines a base file structure for storing and transporting media, including audio and video. A file based on the ISOBMFF has a logical structure with a so-called movie comprising one or more time-parallel tracks where each track is a media stream. The tracks contain sequences of samples in time, where each sample can have a decoding time, a composition time and a presentation time.

For video, a sample corresponds to a picture. Each track has a specific media type (audio, video, etc), and is further parameterized by a sample entry, including the identifier of the media type used (e.g. the video codec). Each sample in a track may be associated with a sample group, where a sample group is grouping samples with a specific property, e.g. all samples in the group being random access samples. The physical structure of an ISOBMFF file is a series of specific defined boxes (sometimes called atoms), in a hierarchical setup, with the boxes describing the properties of the media for the movie and for each track. Each box has a length, type, flags and data. The media data for the samples, e.g., the compress video bitstream, is stored unstructured in ‘mdat’ or ‘idat’ boxes in the same file or in a separate file.

Many of the MPEG systems specifications inherits structures and boxes from ISOBMFF, including MPEG-DASH, Carriage of NAL unit structured video in the ISOBMFF, Omnidirectional Application Format (OMAF) and the Carriage of PCC data.

### Carriage of NAL Unit Structured Video in the ISOBMFF

The Carriage of NAL unit structured video in the ISOBMFF specified in ISO/IEC 14496-15 specifies the storage format for video streams encoded with AVC, HEVC and VVC. This includes definitions of how to derive from the ISOBMFF, the sample groups to use for the different random access types, entity groups to be used for subpictures and operating points, and how to packetize layers into different tracks. This specification is used by other MPEG specifications for carriage of video data compressed with AVC, HEVC, and VVC, including MPEG-DASH and carriage of PCC data.

### MPEG-DASH

MPEG-DASH (Dynamic Adaptive Streaming over HTTP) specified in ISO/IEC 23009 is an adaptive bitrate streaming technology where a multimedia file is partitioned into one or more segments and delivered to a client using HTTP, typically over TCP. MPEG-DASH may sometimes be referred to as only DASH. DASH may also refer to the reduced version of MPEG-DASH promoted by the DASH Industry Forum (IF). An MPEG-DASH session is set up using a media presentation description (MPD) that describes segment information including timing, URL and media characteristics like video resolution and bit rates.

MPDs, which are XML-based, can be static, e.g. for movies, or dynamic, such as for live content. Segments can contain any media data, however the specification provides specific guidance and formats for use with two types of containers: ISO base media file format or MPEG-2 Transport Stream. One or more representations of multimedia files, e.g., versions at different resolutions or bit rates, are typically available, and selection can be made based on network conditions, device capabilities and user preferences, enabling adaptive bitrate streaming.

Within the root MPD element is one or more Period elements. A Period represents a window of time in which media is expected to be presented. Each Period contains one or more AdaptationSet elements. An AdaptationSet describes a single media element available for selection in the presentation. A reason to use multiple AdaptationSets is when there are multiple copies of the media that use different video codecs, which would enable playback on clients that only support one codec or the other. Also, clients may want to be able to select between multiple language audio tracks or between multiple video viewpoints.

An AdaptationSet contains one or more Representations. Every AdaptationSet contains a Representation element for each quality-level (bandwidth value) of media available for selection where different video resolutions and bitrates may be available for selection. A Representation may also have Sub-Representations valid for a shorter time period than the representation. Elements and attributes in the AdaptationSet, Representation and Sub-Representation include the codecs and ptl elements and attributes for defining the codecs settings for the session. The structure of the MPD is exemplified in FIG. 2.

Another popular protocol used in adaptive video streaming is the HTTP Live Streaming (HLS) protocol developed by Apple. HLS resembles MPEG-DASH in that it works by breaking the overall stream into a sequence of small HTTP-based file downloads, each downloading one short chunk of an overall potentially unbounded transport stream. A list of available streams, encoded at different bit rates, is sent to the client using an extended M3U playlist.

Although MPEG-DASH and HLS are very similar they are not compatible by their own, meaning that a service provider wanting to support both formats would have to be able to deliver content for each of the two container formats. In an effort to alleviate this market fragmentation and simplify adaptive video streaming, MPEG has developed the Common Application Media Format (CMAF), ISO/IEC 23000-19, which defines a common subset of the MPEG-DASH and HLS formats using the ISO base media container format, such that a service provider would only need to be able to deliver content for a single container format, which will save costs and reduce time-to-market.

The Real-Time Messaging Protocol (RTMP) from Macromedia and the open-source Secure Reliable Transport (SRT) are two other video transport protocols used in the market.

### Media Transport in IETF

The Internet Engineering Task Force (IETF) have developed a number of protocols for media transport and media session setup. Some of these protocols are described below.

### Real-Time Transport Protocol

The Real-time Transport Protocol (RTP) specified in RFC 3550 is a network protocol for sending audio and video over IP networks. RTP is typically used in communication and entertainment systems that involve streaming media, such as telephony, video teleconference applications including WebRTC, IPTV and web-based push-to-talk features. RTP is typically run over User Datagram Protocol (UDP) and often together with the RTP Control Protocol (RTCP) that monitors transmission statistics and quality of service (Qos).

The information provided by RTP includes timestamps (for synchronization), sequence numbers (for packet loss and reordering detection) and the payload format which indicates the encoded format of the data. The Real-Time Streaming protocol (RTSP) is a network protocol used for controlling streaming media servers. Media clients sends commands such as play, skip and pause to the media server to facilitate control of media streaming from the server to the client, also referred to as Video on Demand.

RTP is designed to carry a multitude of multimedia formats, which permits the development of new formats without revising the RTP standard. RTP therefore defines profiles and associated payload formats. Examples of RTP profiles include the RTP Profile for Audio and Video (RTP/AVP) specified in RFC 3551 and the Secure Real-time Transport Protocol (SRTP) for encrypting transfer of payload data specified in RFC 3711. RTP payload formats specify how certain media formats, e.g. media encoded with certain codecs, are packetized and transported. RTP payload formats have been specified for a number of audio, video and picture codecs, including H.264 (RFC 6184), HEVC (RFC 7798), JPEG (RFC 2435) and JPEG XS (RFC 9134). The development of the RTP payload format for VVC is ongoing in IETF.

### Session Description Protocol

The Session Description Protocol (SDP) specified in RFC 8866 is a format for describing multimedia communication sessions for the purposes of setting up a connection. Its predominant use is in support of streaming media applications, such as voice over IP (VOIP) and video conferencing. SDP does not deliver any media streams itself but is used between endpoints for negotiation of network metrics, media types, and other associated properties. The set of properties and parameters is called a session profile. SDP is typically used in conjunction with RTP, RTSP, the Session Initiation Protocol (SIP), and as a standalone protocol for describing multicast sessions.

The session descriptions in SDP consists of three sections: session, timing and media description. An example of an SDP session description is shown below, where the media description (the rows with the a and m characters) describes that the media can only be received, the audio is sent on port 49170 and encoded with PCMU (payload type 0) and the video is sent on port 51372 and encoded with H.265.

```
v=0
  o=jdoe 2890844526 2890842807 IN IP4 10.47.16.5
  s=sessionName
  t=0 0
  a=recvonly
  m=audio 49170 RTP/AVP 0
  m=video 51372 RTP/AVP 98
  a=rtpmap:98 H265/90000
  a=fmtp:98 profile-id=1;
    sprop-vps=<video parameter sets data>
```

The SDP offer/answer model, first specified in RFC 3264 and later updated in RFC 8843, uses SDP to negotiate a common view of a multimedia session between two participants. In the model, one participant offers the other a description of the desired session from their perspective, and the other participant answers with the desired description of the session from their perspective. To be more precise, one participant in the session generates an SDP message that constitutes the offer—the set of media streams and codecs the offerer wishes to use, along with the IP addresses and ports the offerer would like to use to receive the media.

The offer is conveyed to the other participant, called the answerer. The answerer generates an answer, which is an SDP message that responds to the offer provided by the offerer. The answer has a matching media stream for each stream in the offer, indicating whether the stream is accepted or not, along with the codecs that will be used and the IP addresses and ports that the answerer wants to use to receive media. When a session description can be agreed upon, the session can be setup and the media exchange can start.

### Secure FRAME

IETF is currently working on the Secure FRAME (SFRAME), an end-to-end encryption and authentication mechanism for media frames in a multiparty conference call, where central media servers (SFUs) can access the media metadata needed to make forwarding decisions without having access to the actual media data. SFRAME is intended to be used with or without RTP. When used with RTP it is proposed to use a generic RTP payload type such that the media information and the RTP payload header can be encrypted.

### WebRTC

WebRTC is an API for web programming supporting real-time communication (RTC) between web browsers and mobile applications in for instance video conferencing. Originally developed by Google, it has been adopted as an industry standard by W3C and IETF. The RTCPeerConnection component enables audio and video communication between peers and performs signal processing, codec handling, peer-to-peer communication, security, and bandwidth management.

### Neural Networks

The recent advances in neural network (NN) technology have led to ground-breaking discoveries within a large number of application areas, including finance, marketing, image detection and classification, which has resulted in an explosion of interest in the technology. The video coding community is no exception. JVET is currently conducting experiments on video coding using NN technology for the next generation video coding.

A neural network model is built up of a number of connected nodes (neurons) distributed over a number of layers. In the first layer the data to be processed is input and in the last layer the processed data is output. The intermediate layers comprise of various types of layers including convolutional layers, pooling layers, dropout layers, flatten layers and fully connected layers. Each node in the NN model has its own weight used to amplify the value from the previously connected nodes.

### Neural Networks for Image and Video Compression

Neural-network-based techniques for image and video coding and compression have been explored especially after introduction of convolutional neural networks (CNNs) which provide a reasonable trade-off between the number of the neural network model parameters and trainability of the neural network model. CNNs have a smaller number of parameters compared to fully connected neural networks which makes the large-scale neural network training possible.

There are two technological development tracks for using neural networks for image and video compression: One track is integrating neural networks into an existing codec by replacing one or more of the modules in the existing block-based image and video coding standards with a neural network model to improve the coding efficiency, and another track is the end-to-end track which replaces the entire codec with a neural network module with the possibility for end-to-end training and optimization. Both tracks are currently being explored in the scientific community.

However, it is the codec standardization activities for image compression (rather than video compression) that is exploring the end-to-end track in a more structures way, including the ongoing activities in JPEG AI, while the ongoing video compression standardization activities are investigating the module replacement track in a more structured way, including the ongoing activities in the EE1 in JVET. One reason for this is the considerably higher complexity of the end-to-end video codecs compared to the image codecs. Another reason is that the scientific community has so far been more successful in handling image data with end-to-end approaches rather than handling motion data. More information about neural-network-based video coding activities in JVET are provided in the following section.

### Neural-Network-Based Video Coding Activities in JVET

In the 19th JVET meeting, it was agreed (JVET-S2000) to establish an ad-hoc group (AHG) with the goal of developing a potential VVC extension supporting learning-based video coding tools. Following this decision, neural-network-based video coding (AHG11) was established with the following initial mandates:

(1) Study potential extensions of VVC with NN-based coding tools for video coding, such as intra or inter prediction modes, partitioning, transforms, and in-loop or post filtering.

(2) Study NN-based encoding optimization for VVC.

(3) Study the impact of training on the performance of candidate technology.

(4) Analyze complexity characteristics and perform complexity analysis of candidate technology.

(5) Identify video test materials, training set materials, and testing methods for assessment of the effectiveness and complexity of considered tools.

(6) Develop reporting templates for test results and analysis of candidate technology.

(7) Coordinate with relevant activities of the parent bodies.

AHG11 was a follow up to the AHG9 for investigating the compression performance and complexity of neural network-based coding tools which was set up in early 2018 and continued for several meeting cycles until after the P meeting, as it was necessary to prioritize work on other aspects of the VVC design to finalize the VVC v1 standard on time.

In the 20^{th} JVET meeting an exploration experiment (EE) on neural-network-based video coding was established. This EE was continued in the 21^{st} up to the 25^{th} (the most recent) JVET meetings with several EE tests including tests on NN-based filtering and NN-based super resolution between the 20^{th} and the 23^{rd} JVET meetings, and tests on NN-based enhancement filters, NN-based super resolution and NN-based intra prediction after the 23^{rd} JVET meeting.

Here are some of the items on the list of the mandates for neural-network-based video coding ad-hoc group in JVET from JVET-X1000 (24^{th} JVET meeting):

(1) Evaluate and quantify performance improvement potential of NN-based video coding technologies compared to existing video coding standards such as VVC, including both individual coding tools and novel architectures.

(2) Finalize, conduct and discuss the EE on neural network-based video coding.

(3) Refine the test conditions for NN-based video coding. Generate and distribute anchor encoding, and develop supporting software as needed.

(4) Investigate technical aspects specific to NN-based video coding, such as encoding and decoding complexity of neural networks, design network representation, operation, tensor, on-the-fly network adaption (e.g. updating during encoding) etc;

(5) Study the impact of training (including the impact of loss function) on the performance of candidate technology, and identify suitable materials for training.

(6) Analyse complexity characteristics, perform complexity analysis, and develop complexity reductions of candidate technology.

(7) Refine testing methods for assessment of the effectiveness and complexity of considered technology.

(8) Study the impact of parameter quantization and fixed-point computations in NN-based video coding.

(9) Study and collect information related to near-term and longer-term architectures for neural network-based video coding.

The above list includes more items and more detailed items compared to the initial list of mandates which hints at the growing interest and level of investigation in the neural-network-based video coding ad-hoc group in JVET. Complexity-performance tradeoff analysis has been a main objective from the start of the exploration experiment on neural-network-based video coding and complexity related aspects of the neural networks for video coding such as encoding and decoding complexity of neural networks, analysis of the complexity characteristics and complexity reduction for the considered technologies are among the highlighted topics for investigation on the list of neural-network-based video coding ad-hoc group mandates.

### SUMMARY

As discussed above, profile, tier, and level definitions are provided for video codecs such as High Efficiency Video Coding (HEVC) and Versatile Video Coding (VVC). These profile, tier, and level definitions are useful for indicating the minimum requirements for a decoder to decode a bitstream.

However, in case one or more neural networks (NN) is used at a decoder for decoding a bitstream, the requirements for the decoder to decode a bitstream using NN(s) are more complex because such decoding requires certain dedicated hardware. Thus, different decoders may have different NN decoding capabilities (i.e., capabilities of decoding bitstreams using NNs) despite having the same or equivalent traditional decoding capabilities. Therefore, providing profile, tier, and/or level definitions to a decoder may not be sufficient to convey to the decoder the required capability for decoding a bitstream as the profile, tier, and/or level definitions do not include the NN decoding capability required for the decoder to decode the bitstream.

Accordingly, in one aspect, there is provided a method performed by a first entity. The method comprises obtaining decoding information and conveying the obtained decoding information towards a second entity. The decoding information includes at least one neural network, NN, complexity value, and said at least one NN complexity value indicates NN decoding capability for using one or more NN models in a decoding process of a video bitstream.

In another aspect, there is provided a method performed by a second entity. The method comprises receiving decoding information conveyed by a first entity. The decoding information includes at least one neural network, NN, complexity value, and said at least one NN complexity value indicates NN decoding capability for using one or more NN models in a decoding process of a video bitstream.

In another aspect, there is provided a computer program comprising instructions which when executed by processing circuitry cause the processing circuitry to perform the method of any one of embodiments described above.

In another aspect, there is provided a first entity. The first entity is configured to convey decoding information towards a second entity. The decoding information includes at least one neural network, NN, complexity value, and said at least one NN complexity value indicates NN decoding capability for using one or more NN models in a decoding process of a video bitstream.

In another aspect, there is provided a second entity. The second entity is configured to receive decoding information conveyed by a first entity. The decoding information includes at least one neural network, NN, complexity value, and said at least one NN complexity value indicates NN decoding capability for using one or more NN models in a decoding process of a video bitstream.

In another aspect, there is provided an apparatus. The apparatus comprises a memory and processing circuitry coupled to the memory. The apparatus is configured to perform the method of any one of embodiments described above.

One advantage of the embodiments of this disclosure is that, by conveying to a decoder information about the NN decoding capability (a.k.a., NN complexity) required for decoding a bitstream (e.g., using at least one NN decoding capability value V), the decoder can determine whether it can decode the bitstream using its NN and decode the bitstream based on the determination. In some embodiments, the information about the NN decoding capability includes a plurality of NN decoding capability values each of which indicates a different level of NN decoding capability.

In such embodiments, upon receiving the information, the decoder may select one or more of the plurality of NN decoding capability values based on its decoding capability. The conveyed NN complexity value(s) may be used in setting up a video stream session or in a session negotiating for setting up a video conferencing session where the bitstream for the video stream session or the video conferencing session may be encoded with a certain NN complexity.

### BRIEF DESCRIPTION OF THE DRAWINGS

The accompanying drawings, which are incorporated herein and form part of the specification, illustrate various embodiments.

FIG. 1A shows a system according to some embodiments.

FIG. 1B shows a system according to some embodiments.

FIG. 1C shows a system according to some embodiments.

FIG. 2 shows an exemplary neural network.

FIG. 3 shows a message flow diagram corresponding to a process according to some embodiments.

FIG. 4 shows a message flow diagram corresponding to a process according to some embodiments.

FIG. 5 shows a message flow diagram corresponding to a process according to some embodiments.

FIG. 6 shows a message flow diagram corresponding to a process according to some embodiments.

FIG. 7 shows a process according to some embodiments.

FIG. 8 shows a process according to some embodiments.

FIG. 9 shows a structure of an encoder and/or a decoder according to some embodiments.

FIG. 10 shows a relation between layer access units and coded layer video sequences.

FIG. 11 shows an example of MPD.

### DETAILED DESCRIPTION

The following terminologies are used in the description of the embodiments below:

Neural network: a generic term for an entity with multiple layers of simple processing units called neurons or nodes having activation functions and interacting with each other via weighted connections and biases, which collectively create a tool in the context of non-linear transforms.

Neural network architecture, network architecture, or architecture in short: the layout of a neural network describing the placement of the nodes and their connections, usually in the form of several interconnected layers, and may also specify the dimensionality of the input(s) and output(s) as well as the activation functions for the nodes.

Neural network weights, or weights in short: The weight values assigned to the connections between the nodes in a neural network.

Neural network model, or model in short: a transform in the form of a trained neural network. A neural network model may be specified as the neural network architecture, activation functions, biases and weights.

Filter: A transform. A neural network model is one realization of a filter. The term filter may be used as a short form of neural-network-based filter or neural network filter.

Neural network training, or training in short: The process of finding the values for the weights and biases for a neural network. Usually, a training data set is used to train the neural network and the goal of the training is to minimize a defined error. The amount of training data needs to be sufficiently large to avoid overtraining. Training a neural network is normally a time-consuming task and typically comprises a number of iterations over the training data, where each iteration is referred to as an epoch.

Allowed to be used: In the description of the embodiments, the expression “allowed to be used” is used in the context of whether a coding tool is allowed to be used. This is equivalent to saying that the coding tool is enabled or saying that the coding tool may/could be present. Similarly, when using the term “not allowed to be used” or “disallowed” for a coding tool, it is equivalent to saying that the coding tool is disabled or saying that the coding tool is not present.

The following embodiments capture different elements which may be used individually or as a combination.

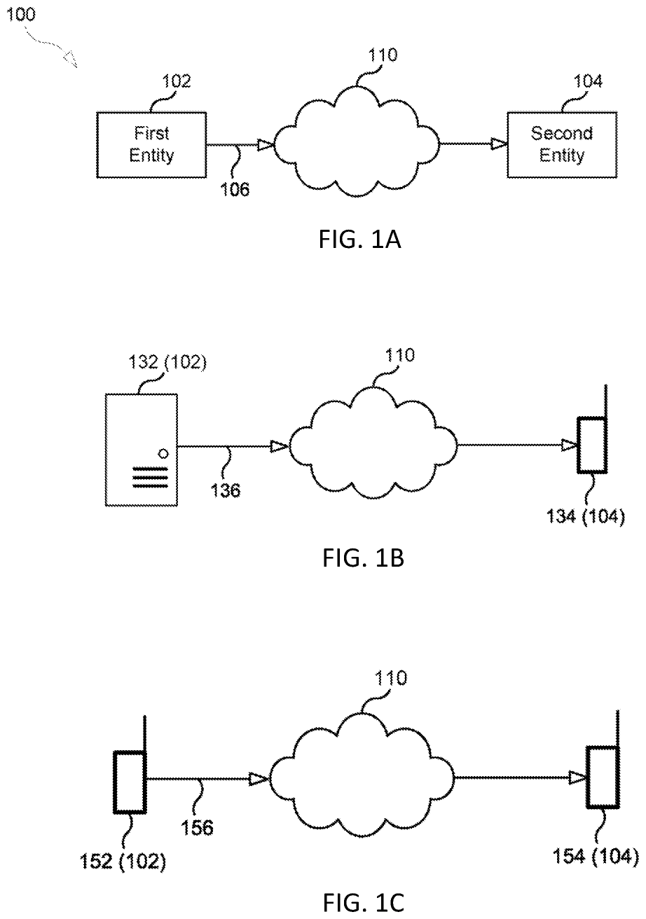

FIG. 1A shows a system 100 according to some embodiments. The system 100 comprises a first entity 102, a second entity 104, and a network 110. The first entity 102 is configured to convey towards the second entity 104 encoding and/or decoding information (herein after, “e/d info”) 106 for at least one video bitstream or at least one video coding operation point.

In some embodiments, the first entity 102 is any computing device (e.g., a network node such as a server) capable of transmitting a video stream (a.k.a., “a video bitstream,” “bitstream,” “an encoded video”) towards the second entity 104 via the network 110. Similarly, in some embodiments, the second entity 104 is any computing device (e.g., a network node) capable of receiving the transmitted video stream.

For example, the first entity 102 is a content providing server configured to store various video contents, encode the video contents, and transmit the encoded video contents towards the second entity 104. In another example, the first entity 102 is a content delivery server that is capable of obtaining various encoded video contents from a content storage entity and delivering the encoded video contents to the second entity 104.

In case the second entity 104 includes a decoder, the second entity 104 is configured to decode the received video stream. In case the second entity 104 does not include any decoder, the second entity 104 may be configured to forward the received video stream towards a decoder.

As discussed above, in some embodiments, the first entity 102 is capable of transmitting a video stream towards the second entity 104. However, in other embodiments, the first entity 102 is not capable of transmitting a video stream towards the second entity 104. In such embodiments, the first entity 102 merely provides the e/d info 106 to the second entity 104.

The first entity 102 may be a single physical entity or a combination of multiple physical entities. The multiple physical entities may be located in the same location or may be distributed in a cloud.

As shown in FIG. 1B, in some embodiments, the first entity 102 is a video streaming server 132 and the second entity 104 is a user equipment (UE) 134. The UE 134 may be any of a desktop, a laptop, a tablet, a mobile phone, or any other computing device. The video streaming server 132 is capable of sending a video bitstream 136 (e.g., YouTube™ video streaming) to the video streaming client 134.

As shown in FIG. 1C, in other embodiments, the first entity 102 and the second entity 104 are first and second UEs 152 and 154. For example, the first UE 152 may be an offeror of a video conferencing session or a caller of a video chat and the second UE 154 may be an answerer of the video conference session or the answerer of the video chat. In the embodiments shown in FIG. 1C, the first UE 152 is capable of sending a video bitstream 156 for a video conference (e.g., Zoom™, Skype™, MS Teams™, etc.) or a video chat (e.g., Facetime™) to the second UE 154.

Referring back to FIG. 1A, the e/d info 106 may include at least one neural network (NN) complexity value V (a.k.a., NN decoding capability value(s)) representing NN decoding capability needed for decoding a video bitstream using one or more NN models. More specifically, an NN complexity value V may indicate at least one aspect of NN decoding requirements (a.k.a., “NN decoding capabilities”) needed for a decoder to decode a video bitstream (a.k.a., “a bitstream”) using one or more NN models.

The NN complexity value V may be determined based on one or more of the following parameters each of which may indicate the complexity of one or more NN models to be used for decoding a bitstream:

(1) A computational capability (e.g., the amount of computational resources) required for a decoder to decode a bitstream using one or more NN models. The required computational capability may be measured in the number of Multiply-Accumulate (MAC) or Multiply-Add (MAD) operations per unit, where the MAC or MAD operation computes the product of two numbers and adds that product to an accumulator. The unit may be a time unit such as seconds or a non-time unit such as a pixel, a sample, or a picture.

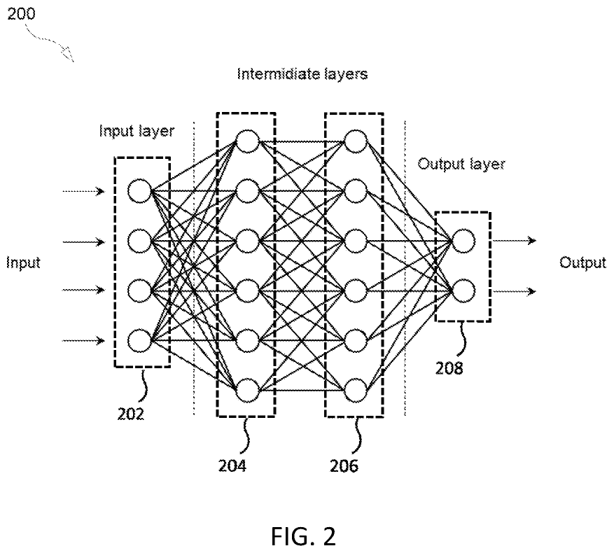

(2) A total size of one or more NN models required for a decoder to decode a bitstream (a.k.a., “required NN model(s)”). FIG. 2 shows an exemplary NN model 200 according to some embodiments. As shown in FIG. 2, the NN model 200 include four layers—an input layer 202, intermediate layers 204 and 206, and an output layer 208. The input layer 202 comprises four nodes, each of the intermediate layers 204 and 206 comprises six nodes, and the output layer 208 comprises two nodes. With respect to the exemplary model 200 shown in FIG. 2, the total size of the required NN model(s) may be defined by any combination of the followings: the number of intermediate layers included in the NN model(s), the number of nodes in the input layer 202, and the number of nodes in each of the intermediate layers 204 and 206 in the NN model(s).

(3) A type of architecture of the required NN model(s). For examples, different types of architecture of the required NN model(s) may include a single-layer feed forward network, a multilayer feed forward network, a single node network with its own feedback, a single-layer recurrent network, and a multilayer recurrent network.

(4) A number of nodes, input parameters, and/or weights of the required NN model(s).

(5) Information (e.g., the number of bits used to represent input parameter(s), the number of decimal points, etc.) related to input parameter(s) of the required NN model(s).

(6) A number of layers in the required NN model(s) (e.g., a total number of layers included in the required NN model(s) or the number of layers of a specific type, e.g., fully connected layers or convolutional layers, included in the required NN model(s)).

(7) A batch size of the required NN model(s)

(8) A patch size of the required NN model(s).

(9) A memory requirement of storing the required NN model(s) (e.g., in bytes).

(10) An amount of a memory needed for storing input parameters of the required NN model(s) s (e.g., in bytes); and

(11) A type of hardware architecture used by the required NN model(s).

The above listed parameters may be defined or provided for a single NN model or for all NN models used to decode a bitstream. For example, in case two NN models are used for decoding a bitstream, the above listed parameters may be applicable to each of the two NN models or a combination of the two NN models.

Also, each of the above listed parameters may indicate a maximum (peak) value that a decoder is required to handle or may indicate an average (median) value over a certain time period that a decoder is required to handle.

As discussed above, the NN complexity value V is a metric used for measuring at least one aspect of the capability (complexity) of one or more NN models, that is needed for decoding one or more bitstreams. Thus, in some embodiments, the NN complexity value V may be equal to a value of any one of the above listed parameters.

However, in other embodiments, the NN complexity value V may be determined based on a combination of two or more of the above listed parameters. In other words, the NN complexity value V may be a function of two or more parameters. For example, V=f (MAC per unit, the number of nodes, etc.).

In the above discussed embodiments, instead of conveying the whole NN model(s) or majority parts of the NN model(s) from which the required NN decoding capability can be derived, smaller data, i.e., one or more values representing the required NN decoding capability associated with one or more bitstream or operating points, is conveyed to a receiving entity such that less data bandwidth is used for conveying the necessary decoding information.

In addition to the NN complexity value(s), the e/d info 106 may also indicate a video codec format (e.g., profile, tier, and/or level) associated with a video codec to which the at least one video bitstream or the at least one video coding operation point conforms. Also, in some embodiments, the e/d info 106 may specify at least one of an Output Layer Set (OLS) and an operation point.

In some embodiments, the first entity 102 may comprise a video encoder capable of encoding a video using one or more NN models, thereby generating an encoded video, and the second entity 104 may comprise a video decoder capable of decoding the encoded video (a.k.a., a video bitstream) using one or more NN models. The video decoder included in the second entity 104 has a certain level of capability of decoding an encoded video using one or more NN models. In this disclosure, such certain level of capability is referred as the decoder's NN decoding complexity (or the decoder's NN decoding capability).

In some scenarios, the decoder included in the second entity 104 has the NN decoding capability needed for decoding one or more video bitstreams using one or more NN models, which is indicated by the NN complexity value(s) included in the e/d info 106. In such scenarios, once the second entity 104 determines that it has the required NN decoding capability, the second entity 104 may transmit towards the first entity 102 an acknowledgement message indicating that the second entity 104 has the required NN decoding capability.

There are various ways for the second entity 104 to determine whether it has the required NN decoding capability. In one example, a NN complexity value indicating NN decoding capability of one or more NN models included in the second entity 104 for decoding one or more bitstream may be stored in the second entity 104, and the second entity 104 may compare the received NN complexity value to its stored NN complexity value. As a result of determining that the stored NN complexity value is greater than or equal to the received NN complexity value, the second entity 104 may determine that its decoder has the requested NN decoding capability.

On the other hand, there may be a scenario where the decoder included in the second entity 104 may not have the NN decoding capability needed for decoding a video bitstream using one or more NN models, which is indicated by the NN complexity value(s) included in the e/d info 106. In such scenario, the decoder will not be able to decode the bitstream using one or more NN models. In some embodiments, in such scenario, the decoder may rely on the conventional non-NN based decoding technique to decode the bitstream.

There may also be a scenario where a bitstream to be decoded includes a first group of one or more portions of which the decoding does not require the use of any NN models and a second group of one or more portions of which the decoding requires the use of NN models. In such scenario, in case the second entity 104 does not have the required NN decoding capability, the second entity 104 may choose not to decode the second group of one or more portions using its NN models. As discussed above, in some embodiments, in such scenario, the decoder may rely on the conventional non-NN based decoding technique to decode the bitstream.

In some embodiments, the e/d info 106 may include more than one NN complexity values each of which represents a different NN decoding capability needed for decoding one or more video bitstream using one or more NN models. For example, the e/d info 106 may include a first NN complexity value indicating a first NN decoding capability that can be used by one or more NNs for decoding a bitstream and a second NN complexity value indicating a second NN decoding capability that can be used by one or more NNs for decoding a bitstream.

In such embodiments, upon receiving the e/d info 106, the second entity 104 may select one of the multiple NN complexity values depending on a given decoding capability. For example, in case a decoder provided with the second entity 104 does not have first NN decoding capability but has the second NN decoding capability, then the second entity 104 may choose the second NN complexity value and transmit towards the first entity 102 the selection of the second NN complexity value.

There are different ways to convey the e/d info 106 from the first entity 102 towards the second entity 104. For example, in some embodiments, the e/d info 106 may be included in the associated bitstream—i.e., the bitstream that is subject to the decoding. In another example, the e/d info 106 is not included in the bitstream but may be provided to the second entity 104 as metadata in a separate channel. Also, in some embodiments, the e/d info 106 may be conveyed by other means, e.g., by a predetermined common understanding of the information, e.g., provided by a standard or a common implementation.

As discussed above, in some embodiments, the e/d info 106 may be included in a bitstream. In case the e/d info 106 is included in a bitstream, the e/d info 106 may be included in a parameter set or a header of the bitstream, such as a video parameter set (VPS), a sequence parameter set (SPS), a picture parameter set (PPS), a picture header (PH), or a slice header (SH). The e/d info 106 may also be signaled in a decoding capability information (DCI) structure or an equivalent decoder session level unit.

In some embodiments, the e/d info 106 may be included in a profile, tier, level (PTL) structure in the bitstream. The PTL structure may be signaled in a parameter set such as VPS and SPS and/or in DCI. Alternatively, the e/d info 106 may be signaled in video usability information (VUI) (e.g., as a part of SPS).

In some embodiments, the e/d info 106 is signaled in a general constraints information (GCI) structure or an equivalent structure. The GCI may be signaled in DCI, VPS, or SPS.

In some embodiments, the at least one neural network (NN) complexity value V may be provided as a constraint, e.g., as a maximum allowed value of a NN property, or as a flag. In those embodiments, where the NN complexity value V is provided as a flag, a first value of the flag, e.g., 1, may specify that the bitstream does not contain any pictures that require a certain NN feature for the decoding, and a second value of the flag, e.g., 1, may specify that the bitstream contains one or more pictures that may require a certain NN feature for the decoding.

As discussed above, in some embodiments, the e/d info 106 is conveyed from the first entity 102 to the second entity 104 via a bitstream. However, in other embodiments, the e/d info 106 is conveyed from the first entity 102 to the second entity 104 by external means (e.g., via metadata possibly provided in a different data channel than the video bitstream, as a constant in the decoder, or provided to a decoder through an application program interface (API)). The e/d info 106 may also be signaled at the systems layer as will be further described in the following embodiments.

In some embodiments, the e/d info 106 is conveyed from the first entity 102 to the second entity 104 as a part of session setup at the systems level between the first entity 102 and the second entity 104.

In one example, the session setup is for a video streaming session. As shown in FIG. 1B, for a video streaming session, first entity 102 corresponds to the video streaming server 132 and the second entity 104 corresponds the video streaming client 134. The video streaming session may be for a live streaming or video-on-demand (VOD) such as streamed TV. In a typical scenario where VoD is used, the video streaming server 132 provides to the video streaming client 134 a set of pre-encoded alternatives for each video content and the video streaming client 134 may choose a preferred alternative depending on its capabilities and network situation.

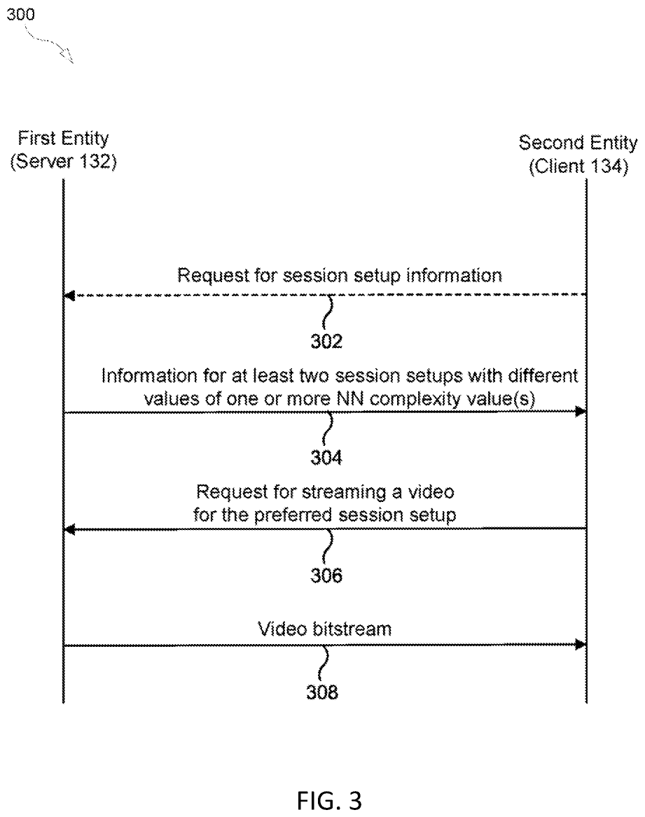

FIG. 3 shows a message flow diagram 300 for an exemplary session setup for a video streaming session, according to some embodiments. The start of a video streaming session may be triggered by the video streaming client 134 sending towards the video streaming server 132 a request 302 for information for a session setup.

In response to receiving the request 302, the video streaming server 132 may send towards the video streaming client 134 information 304 for the session setup. In some embodiments, the information 304 may be directed to one way of setting up the sessions and may describe requirements (capabilities) needed for decoding a bitstream using one or more NN models for the given way of setting up the session. The necessary requirements may be provided as a single NN complexity value V.

Alternatively, the information 304 may include information about at least two different ways of setting up the session. The at least two alternatives may describe different requirements (capabilities) needed for decoding a bitstream using one or more NN models and are associated with different NN complexity values V.

Even though in the embodiments shown in FIG. 3, the video streaming client 134 sends towards the video streaming server 132 the request 302 for session setup, in other embodiments, the bitstream is broadcasted and the video streaming client 134 may not need to send the request 302 for the information 304 for the session setup.

After receiving the information 304, the video streaming client 134 may determine which alternative of the session setup matches its capabilities, if any, and responds to the video streaming server 132 the alternative session setup it wants and requests the video streaming server 132 to start streaming a video.

In some embodiments, the information 304 may include only one alternative for the session setup. Like the embodiments above, the alternative for the session setup may include at least one NN complexity value indicating a capability of one or more NN models required for decoding a bitstream.

Upon receiving the information 304, the video streaming client 134 may determine whether its NN model(s) has the indicated capability and if so, sends towards the video streaming server 132 a request 306 requesting the video streaming server 132 to start streaming a video according to the session setup. As a result of receiving the request 306, the video streaming server 132 may transmit towards the video streaming client 134 a video bitstream 308.

In some embodiments, at least one of the following protocols may be used for the video streaming session; Real-Time Messaging Protocol (RTMP), Secure Reliable Transport (SRT), RealTime Streaming Protocol (RTSP), MPEG-DASH, HTTP Live Streaming (HLS), and Common Media Application Format (CMAF).

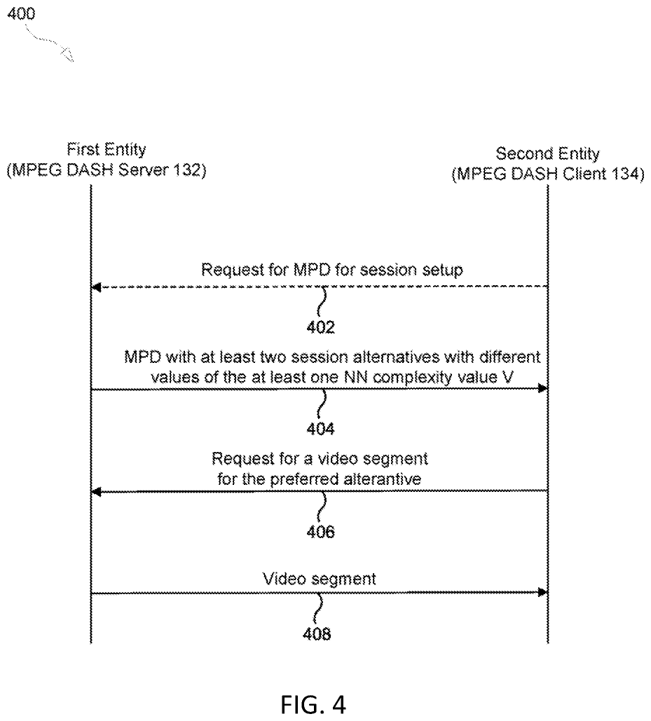

FIG. 4 shows an example of how necessary decoding information can be conveyed from the first entity 102 to the second entity 104 in a video streaming session setup using MPEG-DASH, according to some embodiments. In the embodiments shown in FIG. 4, the first entity 102 is a MPEG-DASH server 132 and the second entity 104 is a MPEG-DASH client 134.

The MPEG-DASH client 134 may send towards the MPEG-DASH server 132 a request 402 for Medial Presentation Description (MPD) for session setup. In response to receiving the request 402, the MPEG-DASH server 132 sends towards the MPEG-DASH client 134 an MPD 404 with at least two session alternatives. The at least two session alternatives indicate different requirements for decoding a video bitstream using one or more NN models. The at least two session alternatives may be associated with different NN complexity values V.

In some embodiments, the NN complexity value V is signaled as an element or an attribute in at least one of an Adaptation Set, Representation or Sub-Representation. The element or attribute may for instance be a “codec” or “ptl” type of element or attribute, or a new type of element or attribute. The MPEG-DASH client 134 may determine from the information in the MPD whether it is capable of performing the decoding using any of the at least two session alternatives.

If the MPEG-DASH client 134 determines that it is capable of performing the decoding using any one or more of the at least two session alternatives, the MPEG-DASH client 134 may send towards the MPEG-DASH server 132 a request 406 for requesting a DASH video segment. The MPEG-DASH client 134 may also initialize the video decoder and allocates enough resources for the decoding based on the at least one NN complexity value V associated with said two session alternatives.

In response to receiving the request 406, the MPEG-DASH server 132 may send towards the MPEG-DASH client 134 a video segment 408. The server 103 may send video segments packet by packet, where a packet comprises a full picture, a partial picture, or multiple pictures. In MPEG-DASH, each packet corresponds to a video segment.

The MPEG-DASH client 134 may decode received video segment 408 and optionally display the decoded video segment.

In some embodiments, instead of conveying the necessary decoding information from the first entity 102 to the second entity 104 as a part of a session setup, the necessary decoding information may be conveyed as a part of a session negotiation at the system levels between the first entity 102 and the second entity 104.

In one example, the session negotiation is made for a video conferencing/chat session (a.k.a., “a peer-to-peer video streaming”). In the video conferencing/chat session, the first entity 102 initiates the session negotiation and is referred as an offeror, and the second entity 104 is referred as an answerer. FIG. 1C shows a video conferencing/chat session in which the first entity 102 serves as an offeror 152 and the second entity 104 servers as an answerer 154.

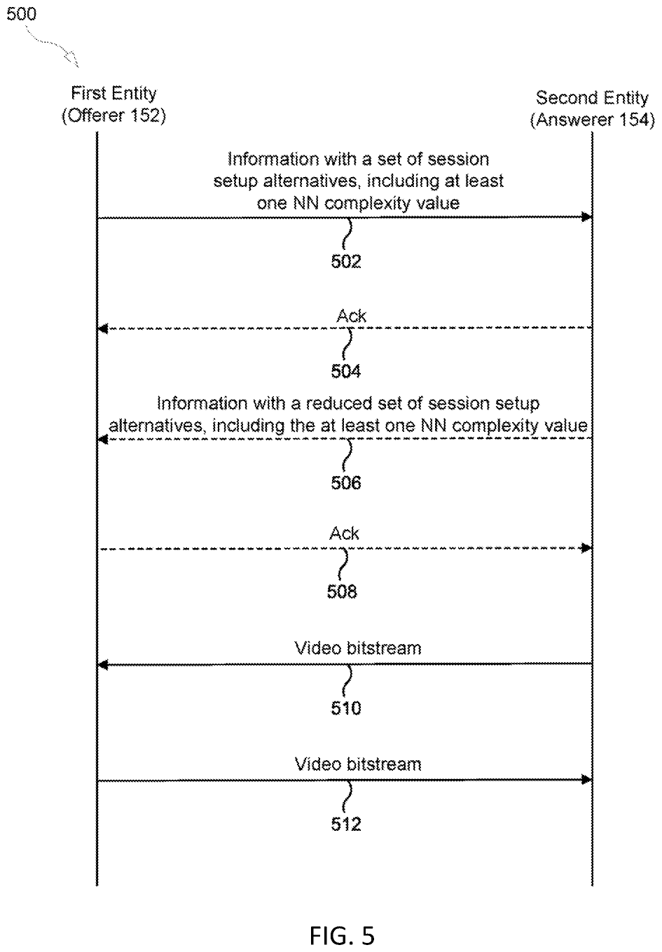

FIG. 5 shows a message flow diagram 500 of an exemplary session negotiation for a video conference or a video chat, according to some embodiments. In FIG. 5, the offeror 152 sends towards the answerer 154 information 502 indicating different session setup alternatives. Each of the different session setup alternatives may indicate a different encoder or decoder capability that can be used (or that may be needed) for performing the video conferencing session.

For example, the information 502 may indicate a first decoding capability and a second decoding capability. Each of the first decoding capability and the second decoding capability corresponds to a capability of one or more NN models that can be used (or that may be needed) for decoding a bitstream to be received from the offeror 152. The information 502 may also indicate a first encoding capability and a second encoding capability. Each of the first encoding capability and the second encoding capability corresponds to a capability of one or more NN models that can be used (or that may be needed) for encoding a video to be sent to the offeror 152. The encoding/decoding capability may be expressed using at least one NN complexity value.

Thus, in one example, the information 502 comprises a first NN complexity value for the first decoding capability, a second NN complexity value for the second decoding capability, a third NN complexity value for the first encoding capability, and a fourth NN complexity value for the fourth decoding capability.

The information 502 may also indicate to the answerer 154 whether to only send a bitstream (e.g., one-way video conferencing), only receive a bitstream (e.g., one-way video conferencing), or both send and receive bitstreams.

In case the answerer 154 can accept the whole set of session setup alternatives, the answerer 154 may respond to the offeror 152 with an acknowledgement message 504 acknowledging that the setup is okay, and a video bitstream exchange for the video conference may begin.

In case the answerer 154 cannot accept the whole set of session setup alternatives, the answerer 154 may respond to the offeror 152 with a reduced set of session setup alternatives. For example, there may be a scenario where the information 502 indicates a first encoding capability, a second encoding capability, a first decoding capability, and a second decoding capability, and the answerer 104 may not have the second encoding capability and the second decoding capability.

In other words, the answerer 154 may only have the first encoding capability and the first decoding capability. In such scenario, after receiving the information 502, the answerer 154 may send a response 506 indicating the first encoding capability and the first decoding capability.

In case the answerer 154 does not have any of the capabilities included in the information 502, the answerer 154 may send towards the offeror 152 the response 506 which includes a reduced encoding/decoding capability (a reduced, e.g., lower, value of the at least one NN complexity value V) that can be used by one or more NN models in the offeror 102.

If the offeror 152 can accept the reduced encoding/decoding capability (i.e., the reduced set of session setup alternatives), the offeror 152 may respond to the answerer 154 with an acknowledgement message 508 and a video conference may begin and video bitstreams 510 and 512 are exchanged between the offeror 152 and the answerer 154.

In one version of the embodiment at least one of Session Description Protocol (SDP), Real-Time Transport Protocol (RTP), Real-Time Streaming Protocol (RTSP), Session Initiation Protocol (SIP), Web Real-Time Communication (WebRTC) and Secure Media Frames (SFRAME) protocols may be used for the session negotiation and/or the video conferencing session.

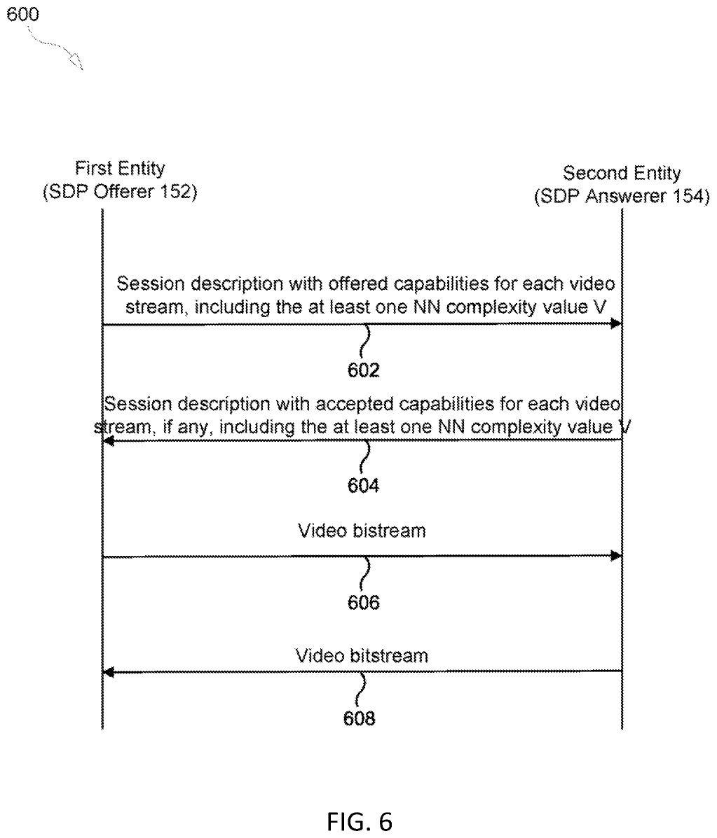

FIG. 6 shows a message flow diagram showing an exemplary process of conveying the necessary encoding/decoding information from the offeror 152 to the answerer 154 in a video conferencing session negotiation using SDP, according to some embodiments.

The offeror 152 may generate an SDP message 602 for session negotiation. The SDP message 602 may comprise a session description with capabilities that can be used (or that may be needed) to decode each video stream in the video conference/chat session. For example, the SDP message 602 may comprise at least one NN complexity value V indicating the capability of one or more NN models, which can be for decoding each video stream, and convey the generated SDP message 602 towards the answerer 154.

In response to receiving the SDP message 602, the answerer 154 may generate an answer in form of a new SDP message 604. In case the answerer 154 have the capabilities indicated in the SDP message 602, the SDP message 604 may simply be an acknowledgement message indicating that the session negotiation is accepted. However, in case the answerer 154 does not have the capabilities indicated in the SDP message 602, the SDP message 604 may indicate a reduced set of session setup alternatives. The reduced set of session setup alternatives may be correspond to at least one NN complexity value V indicating the answerer 154's capabilities for decoding one or more bitstreams using one or more NN models. The above described information may be signaled as a session description in an SDP message.

The SDP message 604 may also include which codec, codec level, resolution, etc., to use for decoding. When the offeror 152 and the answerer 154 have agreed on the session setup, the encoder and decoders can be initialized with the agreed capabilities including allocating enough resources for the decoding based on the at least one NN complexity value V for each video stream. Then the exchange of video bitstreams for each of the negotiated video streams may be started. The video streams may, for instance, be transported over Real-Time Transport Protocol (RTP) or Real-Time Streaming Protocol (RTSP). In some embodiments, the NN complexity value V may be signaled in a “a=fmtp:” line in the SDP message.

In case the SDP message 604 indicates a reduced set of session setup alternatives, in response to receiving the SDP message 604, the offeror 152 may transmit an acknowledgement message indicating that the offeror 152 is okay with the reduced set of session setup alternatives.

If the offeror 152 is to receive a video bitstream 608, the offeror 152 may initialize its video decoder and allocate enough resources for decoding the video bitstream 608 based the NN complexity value(s) included in the SDP message 602 or 604.

Similarly, if the answerer 154 is to send the video bitstream 608, the answerer 154 may initialize its video encoder and send the video bitstream 608 to the offeror 152 after encoding. Here, the NN complexity required for one or more NN models to decode the video bitstream 608 does not surpass the at least one NN complexity value V. The video bitstream 608 may be transported over RTP. The offeror 152 may receive the video bitstream 608, decodes it, and possibly display the decoded video.

On the other hand, if the answerer 154 is to receive a video bitstream 606, the answerer 154 may initialize its video decoder and allocate enough resources for decoding the video bitstream 606 based the NN complexity value(s) included in the SDP message 602 or 604.

Similarly, if the offeror 152 is to send a video bitstream 606, the offeror 152 may initialize its video encoder and send the video bitstream 606 to the answerer 154 after encoding. Here, the NN complexity required for one or more NN models to decode the video bitstream 606 does not surpass the at least one NN complexity value V. The video bitstream 606 may be transported over RTP. The answerer 154 may receive the video bitstream 606, decodes it, and possibly display the decoded video.

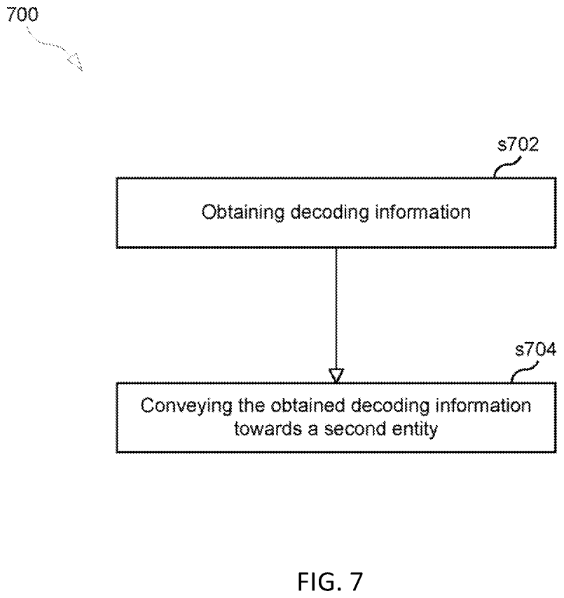

FIG. 7 shows a process 700 performed by a first entity, according to some embodiments. The process 700 may begin with step s702. Step s702 comprises obtaining decoding information. Step s704 comprises conveying the obtained decoding information towards a second entity. The decoding information includes at least one neural network, NN, complexity value, and said at least one NN complexity value indicates NN decoding capability for using one or more NN models in a decoding process of a video bitstream.

In some embodiments, the decoding information indicates any one or more of the followings: a video codec format to which the video bitstream conforms; a profile, a tier, and/or a level associated with a video codec; or an operating point and/or an output layer set, OLS.

In some embodiments, said at least one NN complexity value comprises a first NN complexity value and a second NN complexity value, the first NN complexity value indicates a first NN decoding capability that can be used by one or more NNs for decoding the video bitstream, the second NN complexity value indicates a second NN decoding capability that can be used by one or more NNs for decoding the video bitstream, and the first NN decoding capability and the second NN decoding capability are different.

In some embodiments, the method further comprises receiving selection information indicating a selection of one of the first NN decoding capability and the second NN decoding capability, wherein the selection information was conveyed by the second entity.

In some embodiments, the first entity comprises a video encoder, and/or the second entity comprises a video decoder.

In some embodiments, the method comprises transmitting the video bitstream towards the second entity, and the video bitstream includes the decoding information.

In some embodiments, the decoding information is included in any one or more of the followings: video usability information, VUI; a profile, tier, and level, PTL, structure; a general constraints information, GCI, structure; a decoding capability information, DCI, structure; a video parameter set, VPS; a sequence parameter set, SPS; a picture parameter set, PPS; a picture header, PH; or a slice header, SH.

In some embodiments, said at least one NN complexity value indicates any one or more of the followings: (i) a computational capability (e.g., the number of multiply-accumulate (MAC) or multiply-add (MAC) operations per unit) of one or more NN models needed for decoding the video bitstream; (ii) a total size of said one or more NN models; (iii) a type of architecture used by said one or more NN models; (iv) a number of nodes, a number of input parameters, and/or a number of weights of said one or more NN models; (v) information related to (e.g., the number of bits used to represent the parameter, the number of decimal points, etc.) input parameters of the NN model; (vi) a number of layers included in said one or more NN models; (vii) a batch size of said one or more NN models; (viii) a patch size of said one or more NN models; (ix) a memory requirement of storing said one or more NN models (e.g., in bytes); (x) an amount of a memory needed for storing input parameters of said one or more NN models (e.g., in bytes); and (xi) a type of hardware architecture used by said one or more NN models.

In some embodiments, said at least one NN complexity value comprises a first NN complexity value, and the first NN complexity value is determined using a function of any one or more of (i)-(xi).

In some embodiments, the NN decoding capability indicated by said at least one NN complexity value is any one of a maximum capability or an average capability needed for decoding the video bitstream or the video decoding operating point during a time interval.

In some embodiments, the decoding information does not contain all information needed for constructing a NN model used for decoding the bitstream.

In some embodiments, the decoding information is conveyed as part of a session negotiation or session setup for a video session between the first and the second entity.

In some embodiments, the first entity is a video streaming server, the second entity is a video streaming client, the method further comprises receiving a request for information for setting up a video streaming session, the request was transmitted by the second entity, and the decoding information is transmitted towards the second entity as a result of the first entity receiving the request.

In some embodiments, the method further comprises after transmitting the decoding information, receiving a request for the video bitstream; and as a result of receiving the request for the video bitstream, transmitting the video bitstream.

In some embodiments, the first entity is an offeror of a video conferencing session, the second entity is an answerer of the video conferencing session, the method comprises the first entity initiating a session negotiation for the video conferencing session, and initiating the session negotiation comprises transmitting towards the second entity the decoding information.

In some embodiments, initiating the session negotiation further comprises receiving alternative decoding information including one or more alternative NN complexity values indicating a capability of the second entity's NN for decoding the video bitstream or the video decoding operating point; determining whether the first entity can accept the capability of the second entity's NN; and based on the determination, determining how to generate the video bitstream for the video conferencing session.

In some embodiments, the decoding information is conveyed using at least one of: (i) Real-Time Streaming Protocol, RTSP; (ii) Dynamic Adaptive Streaming DASH; (iii) Motion Picture Experts Group-DASH, MPEG-DASH; (iv) Hypertext Transfer Protocol, HTTP, Living Streaming, HLS; (v) International Standard Organization, ISO, Base Media File Format, ISOBMFF; (vi) Common Media Application Format, CMAF; (vii) Session Description Protocol, SDP; (viii) Real-Time Transport Protocol, RTP; (ix) Session Initiation Protocol, SIP; (x) Web Real-Time Communication, WebRTC; and/or (xi) Secure Frame, SFRAME.

In some embodiments, the decoding information is conveyed using DASH and is conveyed in an Media Presentation Description, MPD, as at least one element or attribute in an Adaptation Set, Representation, or Sub-Representation (e.g., the element or attribute may be a codec, a PTL element or attribute, or a new type of element or attribute).

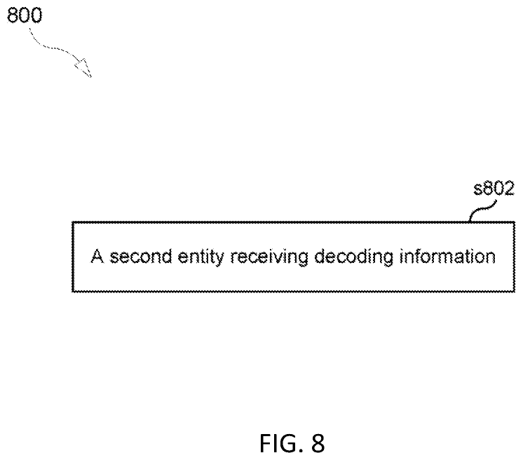

FIG. 8 shows a process 800 performed by a second entity, according to some embodiments. The process 800 comprises step s802. Step s802 comprises receiving decoding information conveyed by a first entity, wherein the decoding information includes at least one neural network, NN, complexity value, and said at least one NN complexity value indicates NN decoding capability for using one or more NN models in a decoding process of a video bitstream.

In some embodiments, the decoding information indicates any one or more of the followings: a video codec format to which the video bitstream or the video coding operating point conforms; a profile, a tier, and/or a level associated with a video codec; or an operating point and/or an output layer set, OLS.

In some embodiments, said at least one NN complexity value comprises a first NN complexity value and a second NN complexity value, the first NN complexity value indicates a first NN decoding capability that can be used by one or more NN models for decoding the video bitstream, the second NN complexity value indicates a second NN decoding capability that can be used by one or more NN models for decoding the video bitstream, and the first NN decoding capability and the second NN decoding capability are different.

In some embodiments, the method further comprises selecting one of the first NN decoding capability and the second NN decoding capability based on a capability of the second entity's NN for decoding the video bitstream; and based on the selection, conveying selection information indicating a selection of one of the first NN decoding capability and the second NN decoding capability.

In some embodiments, the first entity comprises a video encoder; and/or the second entity comprises a video decoder.

In some embodiments, the method comprises receiving the video bitstream transmitted by the first entity; and the bitstream includes the decoding information.

In some embodiments, the method further comprises determining that the second entity does not have the NN decoding capability indicated by said at least one NN complexity value; and as a result of the determination, selectively decoding the video bitstream, wherein selectively decoding the video bitstream comprises not decoding a portion of the video bitstream of which decoding requires the NN decoding capability indicated by said at least one NN complexity value.

In some embodiments, the decoding information is included in any one or more of the followings: video usability information, VUI; a profile, tier, and level, PTL, structure; a general constraints information, GCI, structure; a decoding capability information, DCI, structure; a video parameter set, VPS; a sequence parameter set, SPS; a picture parameter set, PPS; a picture header, PH; or a slice header, SH.

In some embodiments, said at least one NN complexity value indicates any one or more of the followings: (i) a computational capability (e.g., the number of multiply-accumulate (MAC) or multiply-add (MAC) operations per unit) of one or more NN models needed for decoding the video bitstream; (ii) a total size of said one or more NN models; (iii) a type of architecture used by said one or more NN models; (iv) a number of nodes, a number of input parameters, and/or a number of weights of said one or more NN models; (v) information related to (e.g., the number of bits used to represent an input parameter, the number of decimal points, etc.) input parameters of the NN model; (vi) a number of layers included in said one or more NN models; (vii) a batch size of said one or more NN models; (viii) a patch size of said one or more NN models; (ix) a memory requirement of storing said one or more NN models (e.g., in bytes); (x) an amount of a memory needed for storing input parameters of said one or more NN models (e.g., in bytes); and (xi) a type of hardware architecture used by said one or more NN models.

In some embodiments, said at least one NN complexity value comprises a first NN complexity value, and the first NN complexity value is determined using a function of any one or more of (i)-(xi).

In some embodiments, the NN decoding capability indicated by said at least one NN complexity value is any one of a maximum capability or an average capability needed for decoding the video bitstream or the video decoding operating point during a time interval.

In some embodiments, the decoding information does not contain all information needed for constructing a NN model used for decoding the bitstream.

In some embodiments, the decoding information is conveyed as part of a session negotiation or session setup for a video session between the first and the second entity.

In some embodiments, the first entity is a video streaming server, the second entity is a video streaming client, the method further comprises transmitting towards the first entity a request for information for setting up a video streaming session, the request was transmitted by the second entity, and the decoding information is transmitted towards the second entity as a result of the first entity receiving the request.

In some embodiments, the method further comprises after receiving the decoding information, transmitting towards the first entity a request for the video bitstream; and as a result of transmitting the request for the video bitstream, receiving the video bitstream transmitted by the first entity.

In some embodiments, the first entity is an offeror of a video conferencing session, the second entity is an answerer of the video conferencing session, and the method comprises receiving the decoding information during a session negotiation for the video conferencing session.

In some embodiments, the method further comprises, during the session negotiation: transmitting alternative decoding information including one or more alternative NN complexity values indicating a capability of the second entity's NN for decoding the video bitstream or the video decoding operating point; and receiving a response message indicating whether the first entity can accept the capability of the second entity's NN, wherein the response message was transmitted by the first entity.

In some embodiments, the decoding information is conveyed using at least one of: (i) Real-Time Streaming Protocol, RTSP; (ii) Dynamic Adaptive Streaming DASH; (iii) Motion Picture Experts Group-DASH, MPEG-DASH; (iv) Hypertext Transfer Protocol, HTTP, Living Streaming, HLS; (v) International Standard Organization, ISO, Base Media File Format, ISOBMFF; (vi) Common Media Application Format, CMAF; (vii) Session Description Protocol, SDP; (viii) Real-Time Transport Protocol, RTP; (ix) Session Initiation Protocol, SIP; (x) Web Real-Time Communication, WebRTC; and/or (xi) Secure Frame, SFRAME.

In some embodiments, the decoding information is conveyed using DASH and is conveyed in an Media Presentation Description, MPD, as at least one element or attribute in an Adaptation Set, Representation, or Sub-Representation (e.g., the element or attribute may be a codec, a PTL element or attribute, or a new type of element or attribute).

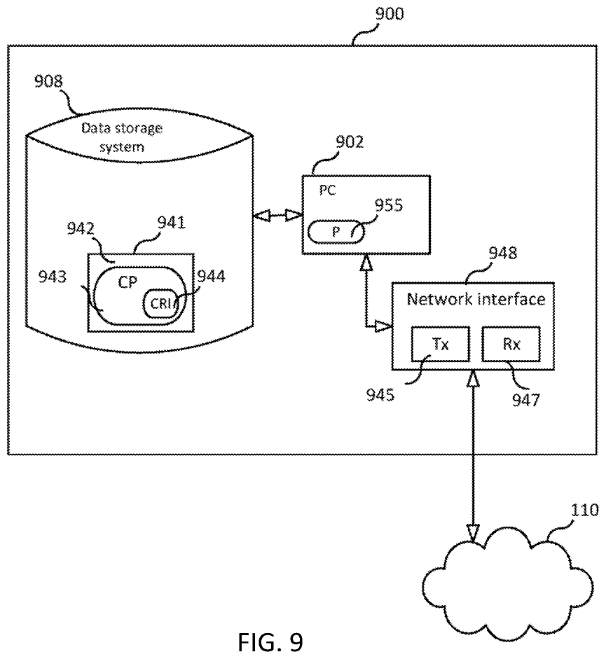

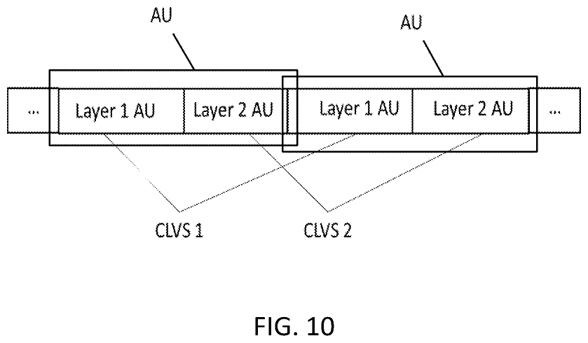

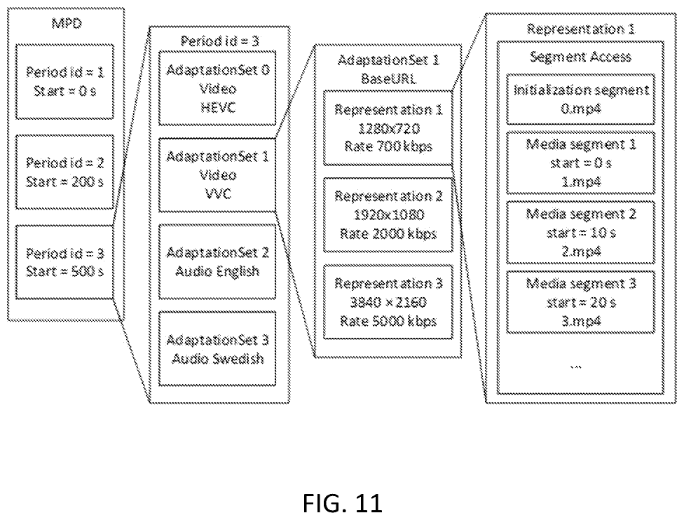

FIG. 9 is a block diagram of an apparatus 900 for implementing the encoder and/or the decoder, according to some embodiments. When apparatus 900 implements a decoder, apparatus 900 may be referred to as a “decoding apparatus 900,” and when apparatus 900 implements an encoder, apparatus 900 may be referred to as an “encoding apparatus 900.” As shown in FIG. 9, apparatus 900 may comprise: processing circuitry (PC) 902, which may include one or more processors (P) 955 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 900 may be a distributed computing apparatus); at least one network interface 948 comprising a transmitter (Tx) 945 and a receiver (Rx) 947 for enabling apparatus 900 to transmit data to and receive data from other nodes connected to a network 110 (e.g., an Internet Protocol (IP) network) to which network interface 948 is connected (directly or indirectly) (e.g., network interface 948 may be wirelessly connected to the network 110, in which case network interface 948 is connected to an antenna arrangement); and a storage unit (a.k.a., “data storage system”) 908, which may include one or more non-volatile storage devices and/or one or more volatile storage devices. In embodiments where PC 902 includes a programmable processor, a computer program product (CPP) 941 may be provided. CPP 941 includes a computer readable medium (CRM) 942 storing a computer program (CP) 943 comprising computer readable instructions (CRI) 944. CRM 942 may be a non-transitory computer readable medium, such as, magnetic media (e.g., a hard disk), optical media, memory devices (e.g., random access memory, flash memory), and the like. In some embodiments, the CRI 944 of computer program 943 is configured such that when executed by PC 902, the CRI causes apparatus 900 to perform steps described herein (e.g., steps described herein with reference to the flow charts). In other embodiments, apparatus 900 may be configured to perform steps described herein without the need for code. That is, for example, PC 902 may consist merely of one or more ASICs. Hence, the features of the embodiments described herein may be implemented in hardware and/or software.

### SUMMARY OF EMBODIMENTS

A1. A method (700) performed by a first entity (102), the method comprising:
obtaining (s702) decoding information; and
conveying (s704) the obtained decoding information towards a second entity, wherein
the decoding information includes at least one neural network, NN, complexity value, and
said at least one NN complexity value indicates NN decoding capability for using one or more NN models in a decoding process of a video bitstream.

A2. The method of embodiment A1, the decoding information indicates any one or more of the followings:
a video codec format to which the video bitstream conforms;
a profile, a tier, and/or a level associated with a video codec; or
an operating point and/or an output layer set, OLS.

A3. The method of embodiment A1 or A2, wherein
said at least one NN complexity value comprises a first NN complexity value and a second NN complexity value,
the first NN complexity value indicates a first NN decoding capability that can be used by one or more NNs for decoding the video bitstream,
the second NN complexity value indicates a second NN decoding capability that can be used by one or more NNs for decoding the video bitstream, and
the first NN decoding capability and the second NN decoding capability are different.

A4. The method of embodiment A3, further comprising receiving selection information indicating a selection of one of the first NN decoding capability and the second NN decoding capability, wherein
the selection information was conveyed by the second entity.

A5. The method of any one of embodiments A1-A4, wherein
the first entity comprises a video encoder, and/or
the second entity comprises a video decoder.

A6. The method of any one of embodiments A1-A5, wherein the method comprises transmitting the video bitstream towards the second entity, and
the video bitstream includes the decoding information.

A7. The method of embodiment A5 or A6, wherein the decoding information is included in any one or more of the followings:
video usability information, VUI;
a profile, tier, and level, PTL, structure;
a general constraints information, GCI, structure;
a decoding capability information, DCI, structure;
a video parameter set, VPS;
a sequence parameter set, SPS;
a picture parameter set, PPS;
a picture header, PH; or
a slice header, SH.

A8. The method of any one of embodiments A1-A7, wherein said at least one NN complexity value indicates any one or more of the followings:
(i) a computational capability (e.g., the number of multiply-accumulate (MAC) or multiply-add (MAC) operations per unit) of one or more NN models needed for decoding the video bitstream;
(ii) a total size of said one or more NN models;
(iii) a type of architecture used by said one or more NN models;
(iv) a number of nodes, a number of input parameters, and/or a number of weights of said one or more NN models;
(v) information related to (e.g., the number of bits used to represent the parameter, the number of decimal points, etc.) input parameters of the NN model;
(vi) a number of layers included in said one or more NN models;
(vii) a batch size of said one or more NN models;
(viii) a patch size of said one or more NN models;
(ix) a memory requirement of storing said one or more NN models (e.g., in bytes);
(x) an amount of a memory needed for storing input parameters of said one or more NN models (e.g., in bytes); and
(xi) a type of hardware architecture used by said one or more NN models.

A9. The method of embodiment A8, wherein
said at least one NN complexity value comprises a first NN complexity value, and
the first NN complexity value is determined using a function of any one or more of (i)-(xi).

A10. The method of any one of embodiments A1-A9, wherein the NN decoding capability indicated by said at least one NN complexity value is any one of a maximum capability or an average capability needed for decoding the video bitstream or the video decoding operating point during a time interval.

A11. The method of any one of embodiments A1-A10, wherein the decoding information does not contain all information needed for constructing a NN model used for decoding the bitstream.

A12. The method of any of embodiments A1-A11 wherein the decoding information is conveyed as part of a session negotiation or session setup for a video session between the first and the second entity.

A12A. The method of embodiment A12, wherein
the first entity is a video streaming server or an offeror of a video conferencing session, and
the second entity is a video streaming client or an answerer of the video conferencing session.

A13. The method of any one of embodiments A1-A12A, wherein
the first entity is a video streaming server,
the second entity is a video streaming client,
the method further comprises receiving a request for information for setting up a video streaming session,
the request was transmitted by the second entity, and
the decoding information is transmitted towards the second entity as a result of the first entity receiving the request.

A14. The method of embodiment A13, further comprising:
after transmitting the decoding information, receiving a request for the video bitstream; and
as a result of receiving the request for the video bitstream, transmitting the video bitstream.

A15. The method of any one of embodiments A1-A14, wherein
the first entity is an offeror of a video conferencing session,
the second entity is an answerer of the video conferencing session,
the method comprises the first entity initiating a session negotiation for the video conferencing session, and
initiating the session negotiation comprises transmitting towards the second entity the decoding information.

A16. The method of embodiment A15, wherein initiating the session negotiation further comprises:
receiving alternative decoding information including one or more alternative NN complexity values indicating a capability of the second entity's NN for decoding the video bitstream or the video decoding operating point;
determining whether the first entity can accept the capability of the second entity's NN; and
based on the determination, determining how to generate the video bitstream for the video conferencing session.

A17. The method of any one of embodiments A1-A16, wherein the decoding information is conveyed using at least one of:
(i) Real-Time Streaming Protocol, RTSP;
(ii) Dynamic Adaptive Streaming DASH;
(iii) Motion Picture Experts Group-DASH, MPEG-DASH;
(iv) Hypertext Transfer Protocol, HTTP, Living Streaming, HLS;
(v) International Standard Organization, ISO, Base Media File Format, ISOBMFF;
(vi) Common Media Application Format, CMAF;
(vii) Session Description Protocol, SDP;
(viii) Real-Time Transport Protocol, RTP;
(ix) Session Initiation Protocol, SIP;
(x) Web Real-Time Communication, WebRTC; and/or
(xi) Secure Frame, SFRAME.

A18. The method of embodiment A17, wherein the decoding information is conveyed using DASH and is conveyed in a Media Presentation Description, MPD, as at least one element or attribute in an Adaptation Set, Representation, or Sub-Representation (e.g., the element or attribute may be a codec, a PTL element or attribute, or a new type of element or attribute).

B1. A method (800) performed by a second entity (104), the method comprising:
receiving (s802) decoding information, wherein
the decoding information includes at least one neural network, NN, complexity value, and
said at least one NN complexity value indicates NN decoding capability for using one or more NN models in a decoding process of a video bitstream.

B1A. The method of embodiment B1, wherein the decoding information is conveyed by a first entity.

B2. The method of embodiment B1 or B1A, wherein the decoding information indicates any one or more of the followings:
a video codec format to which the video bitstream or the video coding operating point conforms;
a profile, a tier, and/or a level associated with a video codec; or
an operating point and/or an output layer set, OLS.

B3. The method of any of embodiment B1-B2, wherein
said at least one NN complexity value comprises a first NN complexity value and a second NN complexity value, wherein
the first NN complexity value indicates a first NN decoding capability for using one or more NN models in a decoding process of the video bitstream,
the second NN complexity value indicates a second NN decoding capability for using one or more NN models in a decoding process of the video bitstream, and
the first NN decoding capability and the second NN decoding capability are different.

B4. The method of embodiment B3, further comprising:
selecting one of the first NN decoding capability and the second NN decoding capability based on a capability of the second entity's NN for decoding the video bitstream; and
based on the selection, conveying selection information indicating a selection of one of the first NN decoding capability and the second NN decoding capability.

B5. The method of any one of embodiments B1-B4, wherein
the first entity comprises a video encoder; and/or
the second entity comprises a video decoder.

B5-2. The method of any of embodiments B1-B5, further comprising:
receiving the video bitstream transmitted by the first entity;
determining that the second entity has the NN decoding capability indicated by said at least one NN complexity value; and
as a result of the determination, decoding the at least one NN model in the video bitstream.

B6. The method of any one of embodiments B1-B5-2, wherein the method comprises receiving the video bitstream transmitted by the first entity; and
the bitstream includes the decoding information.

B7. The method of embodiment B6, further comprising:
determining that the second entity does not have the NN decoding capability indicated by said at least one NN complexity value; and
as a result of the determination, selectively decoding the video bitstream, wherein selectively decoding the video bitstream comprises not decoding a portion of the video bitstream of which decoding requires the NN decoding capability indicated by said at least one NN complexity value.

B8. The method of embodiment B7, wherein the decoding information is included in any one or more of the followings:
video usability information, VUI;
a profile, tier, and level, PTL, structure;
a general constraints information, GCI, structure;
a decoding capability information, DCI, structure;
a video parameter set, VPS;
a sequence parameter set, SPS;
a picture parameter set, PPS;
a picture header, PH; or
a slice header, SH.

B9. The method of any one of embodiments B1-B8, wherein said at least one NN complexity value indicates any one or more of the followings:
(i) a computational capability (e.g., the number of multiply-accumulate (MAC) or multiply-add (MAC) operations per unit) of one or more NN models needed for decoding the video bitstream;
(ii) a total size of said one or more NN models;
(iii) a type of architecture used by said one or more NN models;
(iv) a number of nodes, a number of input parameters, and/or a number of weights of said one or more NN models;
(v) information related to (e.g., the number of bits used to represent an input parameter, the number of decimal points, etc.) input parameters of the NN model;
(vi) a number of layers included in said one or more NN models;
(vii) a batch size of said one or more NN models;
(viii) a patch size of said one or more NN models;
(ix) a memory requirement of storing said one or more NN models (e.g., in bytes);
(x) an amount of a memory needed for storing input parameters of said one or more NN models (e.g., in bytes); and
(xi) a type of hardware architecture used by said one or more NN models.

B10. The method of embodiment B9, wherein
said at least one NN complexity value comprises a first NN complexity value, and
the first NN complexity value is determined using a function of any one or more of (i)-(xi).

B11. The method of any one of embodiments B1-B10, wherein the NN decoding capability indicated by said at least one NN complexity value is any one of a maximum capability or an average capability needed for decoding the video bitstream or the video decoding operating point during a time interval.

B12. The method of any one of embodiments B1-B11, wherein the decoding information does not contain all information needed for constructing a NN model used for decoding the bitstream.

B13. The method of any of embodiments B1-B12 wherein the decoding information is conveyed as part of a session negotiation or session setup for a video session between the first and the second entity.

B14. The method of any one of embodiments B1-B13, wherein
the first entity is a video streaming server,
the second entity is a video streaming client,
the method further comprises transmitting towards the first entity a request for information for setting up a video streaming session,
the request was transmitted by the second entity, and
the decoding information is transmitted towards the second entity as a result of the first entity receiving the request.

B15. The method of embodiment B14, further comprising:
after receiving the decoding information, transmitting towards the first entity a request for the video bitstream; and
as a result of transmitting the request for the video bitstream, receiving the video bitstream transmitted by the first entity.

B16. The method of any one of embodiments B1-B15, wherein
the first entity is an offeror of a video conferencing session,
the second entity is an answerer of the video conferencing session, and
the method comprises receiving the decoding information during a session negotiation for the video conferencing session.

B17. The method of embodiment B16, further comprising, during the session negotiation:
transmitting alternative decoding information including one or more alternative NN complexity values indicating a capability of the second entity's NN for decoding the video bitstream or the video decoding operating point; and
receiving a response message indicating whether the first entity can accept the capability of the second entity's NN, wherein
the response message was transmitted by the first entity.

B18. The method of any one of embodiments B1-B17, wherein the decoding information is conveyed using at least one of:
(i) Real-Time Streaming Protocol, RTSP;
(ii) Dynamic Adaptive Streaming DASH;
(iii) Motion Picture Experts Group-DASH, MPEG-DASH;
(iv) Hypertext Transfer Protocol, HTTP, Living Streaming, HLS;
(v) International Standard Organization, ISO, Base Media File Format, ISOBMFF;
(vi) Common Media Application Format, CMAF;
(vii) Session Description Protocol, SDP;
(viii) Real-Time Transport Protocol, RTP;
(ix) Session Initiation Protocol, SIP;
(x) Web Real-Time Communication, WebRTC; and/or
(xi) Secure Frame, SFRAME.

B19. The method of claim B18, wherein the decoding information is conveyed using DASH and is conveyed in a Media Presentation Description, MPD, as at least one element or attribute in an Adaptation Set, Representation, or Sub-Representation (e.g., the element or attribute may be a codec, a PTL element or attribute, or a new type of element or attribute).

C1. A computer program (943) comprising instructions (944) which when executed by processing circuitry (902) cause the processing circuitry to perform the method of any one of embodiments A1-B19.

C2. A carrier containing the computer program of embodiment C1, wherein the carrier is one of an electronic signal, an optical signal, a radio signal, and a computer readable storage medium.

D1. A first entity (102), the first entity being configured to:
convey (s702) decoding information towards a second entity, wherein
the decoding information includes at least one neural network, NN, complexity value, and
said at least one NN complexity value indicates NN decoding capability for using one or more NN models in a decoding process of a video bitstream.

D2. The first entity of embodiment D1, wherein the first entity is further configured to perform the method of any one of embodiments A2-A18.

E1. A second entity (104), the second entity being configured to:
receive (s802) decoding information conveyed by a first entity, wherein
the decoding information includes at least one neural network, NN, complexity value, and
said at least one NN complexity value indicates NN decoding capability for using one or more NN models in a decoding process of a video bitstream.

E2. The second entity of embodiment E1, wherein the second entity is further configured to perform the method of any one of embodiments B2-B19.

F1. An apparatus (900), the apparatus comprising:
a memory (941); and
processing circuitry (902) coupled to the memory, wherein the apparatus is configured to perform the method of any one of embodiments A1-B19.

### CONCLUSION

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1-30. (canceled)

31. A method performed by a first entity, the method comprising:
obtaining decoding information; and
transmitting a video bitstream towards a second entity, wherein the video bitstream comprises the obtained decoding information, wherein
the decoding information includes at least one neural network, NN, complexity value, and said at least one NN complexity value indicates NN decoding capability for using one or more NN models in a decoding process of a video bitstream,
the first entity comprises a video encoder, and/or
the second entity comprises a video decoder.

32. The method of claim 31, wherein the decoding information is transmitted as part of a session negotiation or session setup for a video session between the first and the second entity, wherein either
the first entity is a video streaming server,
the second entity is a video streaming client,
the method further comprises receiving a request for information for setting up a video streaming session,
the request was transmitted by the second entity, and
the decoding information is transmitted towards the second entity as a result of the first entity receiving the request,
or
the first entity is an offeror of a video conferencing session,
the second entity is an answerer of the video conferencing session,
the method comprises the first entity initiating a session negotiation for the video conferencing session, and
initiating the session negotiation comprises transmitting towards the second entity the decoding information.

33. A method performed by a second entity, the method comprising:
receiving a video bitstream, transmitted by a first entity, wherein the video bitstream comprises decoding information, wherein
the decoding information includes at least one neural network, NN, complexity value,
said at least one NN complexity value indicates NN decoding capability for using one or more NN models in a decoding process of a video bitstream,
the decoding information indicates any one or more of the followings:
a video codec format to which the video bitstream or the video coding operating point conforms;
a profile, a tier, and/or a level associated with a video codec; or
an operating point and/or an output layer set, OLS,
the first entity comprises a video encoder; and/or
the second entity comprises a video decoder.

34. The method of claim 33, wherein
said at least one NN complexity value comprises a first NN complexity value and a second NN complexity value, wherein
the first NN complexity value indicates a first NN decoding capability for using one or more NN models in a decoding process of the video bitstream,
the second NN complexity value indicates a second NN decoding capability for using one or more NN models in a decoding process of the video bitstream, and
the first NN decoding capability and the second NN decoding capability are different.

35. The method of claim 34, further comprising one of:
(1) determining that the second entity has the NN decoding capability indicated by said at least one NN complexity value and, as a result of the determination, decoding the video bitstream using at least one of the one or more NN models, or
(2) determining that the second entity does not have the NN decoding capability indicated by said at least one NN complexity value; and
as a result of the determination, selectively decoding the video bitstream, wherein
selectively decoding the video bitstream comprises not decoding a portion of the video bitstream of which decoding requires the NN decoding capability indicated by said at least one NN complexity value.

36. The method of claim 31, wherein said at least one NN complexity value indicates any one or more of the followings:
(i) a computational capability of one or more NN models needed for decoding the video bitstream;
(ii) a total size of said one or more NN models;
(iii) a type of architecture used by said one or more NN models;
(iv) a number of nodes, a number of input parameters, and/or a number of weights of said one or more NN models;
(v) information related to input parameters of the NN model;
(vi) a number of layers included in said one or more NN models;
(vii) a batch size of said one or more NN models;
(viii) a patch size of said one or more NN models;
(ix) a memory requirement of storing said one or more NN models;
(x) an amount of a memory needed for storing input parameters of said one or more NN models; and
(xi) a type of hardware architecture used by said one or more NN models.

37. The method of claim 31, wherein:
said at least one NN complexity value comprises a first NN complexity value, and
the first NN complexity value is determined using a function of any one or more of (i)-(xi), and/or:
the NN decoding capability indicated by said at least one NN complexity value is any one of a maximum capability or an average capability needed for decoding the video bitstream or the video decoding operating point during a time interval.

38. The method of claim 31, wherein the decoding information does not contain all information needed for constructing a NN model used for decoding the bitstream.

39. The method of claim 33, wherein the decoding information is transmitted as part of a session negotiation or session setup for a video session between the first and the second entity, wherein either
the first entity is a video streaming server,
the second entity is a video streaming client,
the method further comprises transmitting towards the first entity a request for information for setting up a video streaming session,
the request was transmitted by the second entity, and
the decoding information is transmitted towards the second entity as a result of the first entity receiving the request,
or
the first entity is an offeror of a video conferencing session,
the second entity is an answerer of the video conferencing session, and
the method comprises receiving the decoding information during a session negotiation for the video conferencing session.

40. The method of claim 39, further comprising, during the session negotiation:
transmitting alternative decoding information including one or more alternative NN complexity values indicating a capability of the second entity's NN for decoding the video bitstream or the video decoding operating point; and
receiving a response message indicating whether the first entity can accept the capability of the second entity's NN, wherein
the response message was transmitted by the first entity.

41. The method of claim 31, wherein the decoding information is conveyed using at least one of:
(i) Real-Time Streaming Protocol, RTSP;
(ii) Dynamic Adaptive Streaming DASH;
(iii) Motion Picture Experts Group-DASH, MPEG-DASH;
(iv) Hypertext Transfer Protocol, HTTP, Living Streaming, HLS;
(v) International Standard Organization, ISO, Base Media File Format, ISOBMFF;
(vi) Common Media Application Format, CMAF;
(vii) Session Description Protocol, SDP;
(viii) Real-Time Transport Protocol, RTP;
(ix) Session Initiation Protocol, SIP;
(x) Web Real-Time Communication, WebRTC; and/or
(xi) Secure Frame, SFRAME;
(xii) a video usability information, VUI;
(xiii) a profile, tier, and level, PTL, structure;
(xiv) a general constraints information, GCI, structure;
(xv) a decoding capability information, DCI, structure;
(xvi) a video parameter set, VPS;
(xvii) a sequence parameter set, SPS;
(xviii) a picture parameter set, PPS;
(xix) a picture header, PH; and/or
(xx) a slice header, SH.

42. The method of claim 41, wherein the decoding information is transmitted using DASH and is transmitted in a Media Presentation Description, MPD, as at least one element or attribute in an Adaptation Set, Representation, or Sub-Representation.

43. The method of claim 33, wherein said at least one NN complexity value indicates any one or more of the followings:
(i) a computational capability of one or more NN models needed for decoding the video bitstream;
(ii) a total size of said one or more NN models;
(iii) a type of architecture used by said one or more NN models;
(iv) a number of nodes, a number of input parameters, and/or a number of weights of said one or more NN models;
(v) information related to input parameters of the NN model;
(vi) a number of layers included in said one or more NN models;
(vii) a batch size of said one or more NN models;
(viii) a patch size of said one or more NN models;
(ix) a memory requirement of storing said one or more NN models;
(x) an amount of a memory needed for storing input parameters of said one or more NN models; and
(xi) a type of hardware architecture used by said one or more NN models.

44. The method of claim 33, wherein:
said at least one NN complexity value comprises a first NN complexity value, and
the first NN complexity value is determined using a function of any one or more of (i)-(xi), and/or:
the NN decoding capability indicated by said at least one NN complexity value is any one of a maximum capability or an average capability needed for decoding the video bitstream or the video decoding operating point during a time interval.

45. The method of claim 33, wherein the decoding information does not contain all information needed for constructing a NN model used for decoding the bitstream.

46. The method of claim 33, wherein the decoding information is conveyed using at least one of:
(i) Real-Time Streaming Protocol, RTSP;
(ii) Dynamic Adaptive Streaming DASH;
(iii) Motion Picture Experts Group-DASH, MPEG-DASH;
(iv) Hypertext Transfer Protocol, HTTP, Living Streaming, HLS;
(v) International Standard Organization, ISO, Base Media File Format, ISOBMFF;
(vi) Common Media Application Format, CMAF;
(vii) Session Description Protocol, SDP;
(viii) Real-Time Transport Protocol, RTP;
(ix) Session Initiation Protocol, SIP;
(x) Web Real-Time Communication, WebRTC; and/or
(xi) Secure Frame, SFRAME;
(xii) a video usability information, VUI;
(xiii) a profile, tier, and level, PTL, structure;
(xiv) a general constraints information, GCI, structure;
(xv) a decoding capability information, DCI, structure;
(xvi) a video parameter set, VPS;
(xvii) a sequence parameter set, SPS;
(xviii) a picture parameter set, PPS;
(xix) a picture header, PH; and/or
(xx) a slice header, SH.

47. The method of claim 46, wherein the decoding information is transmitted using DASH and is transmitted in a Media Presentation Description, MPD, as at least one element or attribute in an Adaptation Set, Representation, or Sub-Representation.

48. A first entity comprising:
processing circuitry;
a storage medium coupled to the processing circuitry, wherein the storage medium comprises machine readable computer program instructions that, when executed by the processing circuitry, causes the first entity to:
obtain decoding information; and
transmit a video bitstream towards a second entity, wherein the video bitstream comprises the obtained decoding information, wherein
the decoding information includes at least one neural network, NN, complexity value, and said at least one NN complexity value indicates NN decoding capability for using one or more NN models in a decoding process of a video bitstream,
the first entity comprises a video encoder, and/or
the second entity comprises a video decoder.
